(19) United States
(12) Patent Application Publication
(10) Pub. No.: US 2018/0218301 A1
(43) Pub. Date: Aug. 2, 2018

(54) CONSTRUCTION MANAGEMENT SYSTEM AND CONSTRUCTION MANAGEMENT METHOD

(71) Applicant: Komatsu Ltd., Tokyo (JP)

(72) Inventors: Chikashi Shike, Tokyo (JP); Yuichi Nemoto, Tokyo (JP); Masahiro Kurihara, Tokyo (JP)

(21) Appl. No.: 15/747,466

(22) PCT Filed: Oct. 5, 2016
(86) PCT No.: PCT/JP2016/079706

§ 371 Date: Jan. 25, 2018

(30) Foreign Application Priority Data
Oct. 5, 2015 (JP) 2015-198084
Apr. 27, 2016 (JP) 2016-089826

(51) Int. Cl. G06Q 10/06; G06Q 50/08; G06Q 30/06

(52) U.S. Cl. CPC G06Q 10/0637; G06Q 30/0645; G06Q 50/08

(57) ABSTRACT

A construction management system includes a construction plan data calculation unit configured to calculate, based on construction plan data indicating a construction plan of a construction site, the construction plan data having been calculated based on a current landform and a design landform of the construction site and original unit data indicating a specific condition of a work device, necessary work device data indicating a work device necessary for executing construction of the construction site using the construction plan, and a construction plan data output unit configured to cause an output device to output the necessary work device data.

### FIELD

The present invention relates to a construction management system and a construction management method.

### BACKGROUND

In some cases, a work device operating in a construction site is managed by a computer system (refer to Patent Literature 1).

### CITATION LIST

### Patent Literature

Patent Literature 1: Japanese Patent Application Laid-open No. 2002-188183 A

### SUMMARY

### Technical Problem

When a work device necessary for construction of a construction site fails to be smoothly procured, for example, interruption of construction may be caused, and productivity in the construction site may decline.

An object of an aspect of the present invention is to provide a construction management system and a construction management method that can suppress a decline of productivity in a construction site.

### Solution to Problem

According to a first aspect of the present invention, a construction management system comprises: a construction plan data calculation unit configured to calculate, based on construction plan data indicating a construction plan of a construction site, the construction plan data having been calculated based on a current landform and a design landform of the construction site and original unit data indicating a specific condition of a work device, necessary work device data indicating a work device necessary for executing construction of the construction site using the construction plan; and a construction plan data output unit configured to cause an output device to output the necessary work device data.

According to a second aspect of the present invention, a construction management system comprises: a construction plan data calculation unit configured to calculate, based on construction plan data indicating a construction plan of a construction site, the construction plan data having been calculated based on a current landform and a design landform of the construction site and original unit data indicating a specific condition of a work device, and client data indicating a work device owned by a client, necessary work device data indicating a work device necessary for executing construction of the construction site using the construction plan; and a construction plan data output unit configured to cause, based on the necessary work device data, a display device to display a rental service screen of a work device so as to compensate for a work device determined to be deficient in executing construction based on the construction plan.

According to a third aspect of the present invention, a construction management system comprises: an authentication data output unit configured to output code-added construction data obtained by adding an authentication code to construction data of a construction site; an authentication data input unit to which code-added construction data is input from an external device; and a data authentication unit configured to compare an authentication code of code-added construction data output from the authentication data output unit, and an authentication code of code-added construction data input to the authentication data input unit, to determine whether construction data of the code-added construction data output from the authentication data output unit matches construction data of the code-added construction data input to the authentication data input unit.

According to a fourth aspect of the present invention, a construction management method comprises: calculating, based on a current landform and a design landform of a construction site and original unit data indicating a specific condition of a work device, construction plan data indicating a construction plan of the construction site; calculating, based on the construction plan data, necessary work device data indicating a work device necessary for executing construction of the construction site using the construction plan; and causing an output device to output the necessary work device data.

According to a fifth aspect of the present invention, a construction management method comprises: calculating, based on a current landform and a design landform of a construction site and original unit data indicating a specific condition of a work device, construction plan data indicating a construction plan of the construction site; acquiring client data indicating a work device owned by a client; calculating, based on the construction plan data and the client data, necessary work device data indicating a work device necessary for executing construction of the construction site using the construction plan; and causing, based on the necessary work device data, a display device to display a rental service screen of a work device so as to compensate for a work device determined to be deficient in executing construction based on the construction plan.

### Advantageous Effects of Invention

According to an aspect of the present invention, a construction management system and a construction management method that can suppress a decline of productivity in a construction site are provided.

### BRIEF DESCRIPTION OF DRAWINGS

FIG. 1 is a diagram schematically illustrating a construction management system according to the present embodiment.

FIG. 2 is a diagram schematically illustrating a bulldozer according to the present embodiment.

FIG. 3 is a diagram schematically illustrating an excavator according to the present embodiment.

FIG. 4 is a diagram schematically illustrating the excavator according to the present embodiment.

FIG. 5 is a diagram schematically illustrating informatization construction according to the present embodiment.

FIG. 6 is a diagram schematically illustrating informatization construction according to the present embodiment.

FIG. 7 is a diagram illustrating an acquisition method of current landform data according to the present embodiment.

FIG. 8 is a diagram illustrating a hardware configuration of the construction management system according to the present embodiment.

FIG. 9 is a functional block diagram illustrating the construction management system according to the present embodiment.

FIG. 10 is a flowchart illustrating a construction planning method according to the present embodiment.

FIG. 11 is a diagram illustrating an output example of an output device according to the present embodiment.

FIG. 12 is a diagram illustrating an output example of the output device according to the present embodiment.

FIG. 13 is a diagram illustrating an output example of the output device according to the present embodiment.

FIG. 14 is a diagram illustrating an output example of the output device according to the present embodiment.

FIG. 15 is a diagram illustrating an output example of the output device according to the present embodiment.

FIG. 16 is a diagram illustrating an output example of the output device according to the present embodiment.

FIG. 17 is a diagram illustrating an output example of the output device according to the present embodiment.

FIG. 18 is a diagram illustrating an output example of the output device according to the present embodiment.

FIG. 19 is a diagram illustrating an output example of the output device according to the present embodiment.

FIG. 20 is a diagram illustrating an output example of the output device according to the present embodiment.

FIG. 21 is a diagram illustrating an output example of the output device according to the present embodiment.

FIG. 22 is a diagram illustrating an output example of the output device according to the present embodiment.

FIG. 23 is a diagram illustrating an output example of the output device according to the present embodiment.

FIG. 24 is a diagram illustrating an output example of the output device according to the present embodiment.

FIG. 25 is a diagram illustrating an output example of the output device according to the present embodiment.

FIG. 26 is a diagram illustrating an output example of the output device according to the present embodiment.

FIG. 27 is a diagram illustrating an output example of the output device according to the present embodiment.

FIG. 28 is a diagram illustrating an output example of the output device according to the present embodiment.

FIG. 29 is a diagram illustrating an output example of the output device according to the present embodiment.

FIG. 30 is a schematic diagram illustrating an example of the construction management system according to the present embodiment.

FIG. 31 is a functional block diagram illustrating an example of the construction management system according to the present embodiment.

FIG. 32 is a flowchart illustrating an example of a construction management method according to the present embodiment.

FIG. 33 is a schematic diagram illustrating an example of the construction management method according to the present embodiment.

### DESCRIPTION OF EMBODIMENTS

An embodiment according to the present invention will be described below with reference to the drawings. Nevertheless, the present invention is not limited to this. Components in the embodiment to be described below can be appropriately combined. In addition, a part of components are not used in some cases.

[Overview of Construction Management System]

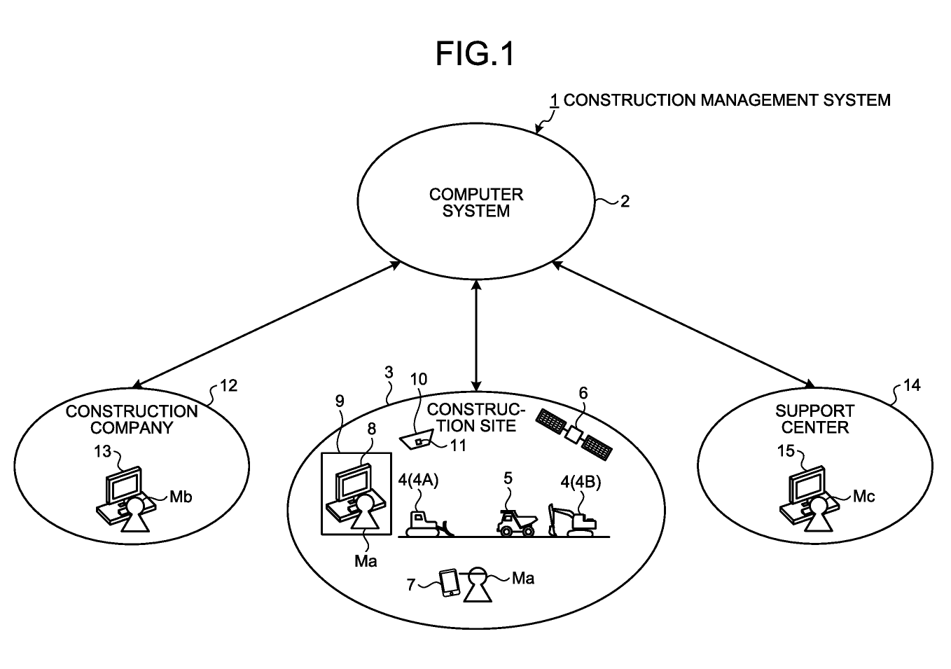

FIG. 1 is a diagram schematically illustrating construction management system 1 according to the present embodiment. The construction management system 1 executes one or both of derivation of a construction plan and visualization of progress statuses of construction. The construction management system 1 includes a computer system 2, and executes construction planning and construction management of a civil engineering construction site 3. In the construction site 3, a work device operates. The work device includes, for example, a construction machine 4 that can execute at least one of earth cutting, earth filling, and land preparation of the construction site 3, and a transporter vehicle 5 that can transport sediment.

The construction machine 4 is an information and communication technology (ICT) construction machine that can execute informatization construction. The informatization construction is a construction method that executes construction highly-efficiently and highly-accurately while paying attention to construction among construction processes including research, design, construction, supervision, testing, and maintenance management, by an information and communication technology (ICT), utilizing electronic data obtained from each process. By electronic data obtained in the construction, being utilized in another process, productivity enhancement and quality securement of the entire construction processes are achieved. With the construction machine 4 that can execute informatization construction, movements of a work device can be automatically controlled, and a current landform can be constructed into a target landform.

The construction machine 4 includes at least either one of a bulldozer 4A and an excavator 4B that have work members. The work members refer to members that have blade edges, and can perform at least one of earth cutting, earth filling, and land preparation of a current landform of the construction site 3. The work member is a blade provided on the bulldozer 4A, or a bucket provided on the excavator 4B. In the construction site 3, the bulldozer 4A performs excavation of sediment, earth cutting, earth dozing, earth filling, and land preparation. The excavator 4B performs excavation of sediment, earth cutting, earth filling, and land preparation.

The transporter vehicle 5 includes a dump truck having a vessel. Sediment is loaded onto the transporter vehicle 5 by the excavator 4B. For example, the transporter vehicle 5 conveys sediment from the construction site 3 to the outside of the construction site 3, and conveys sediment from the outside of the construction site 3 into the construction site 3.

An absolute position indicating a position of a vehicle main body of the construction machine 4 in the global coordinate system (XgYgZg-coordinate system) is detected by the Global Positioning System (GPS) including the GPS satellite 6. A relative position indicating a position of a blade edge of the work member with respect to the vehicle main body of the construction machine 4 in the local coordinate system (XYZ-coordinate system) is detected by a detection device provided in the construction machine 4. Based on the absolute position of the vehicle main body and the relative position between the vehicle main body and the blade edge of the work member, an absolute position of the blade edge of the work member is calculated.

In addition, in the construction site 3, a worker Ma performs works. The worker Ma includes at least either one of an operator of the construction machine 4 and a workman that performs a subsidiary work or the like in the construction site 3. The worker Ma has a mobile terminal 7. The mobile terminal 7 includes a mobile computer such as a smartphone or a tablet personal computer. In addition, a site office 9 is provided in the construction site 3. An information terminal 8 such as a personal computer is installed in the site office 9. The worker Ma performs works using the mobile terminal 7 or the information terminal 8.

In addition, in the construction site 3, a drone 10 for detecting a current landform of the construction site 3 operates. The drone 10 is a flight vehicle that flies without human. The drone 10 includes at least either one of a flight vehicle remotely-manipulated by wireless, and a flight vehicle that automatically ascends, flies according to a preset flight route, and descends to a predetermined position. The drone 10 includes a camera 11. In a state in which the camera 11 is mounted, the drone 10 flies above the construction site 3. The camera 11 provided in the drone 10 aerially takes an image of the construction site 3, and detects a current landform of the construction site 3 in a contactless manner.

The construction management system 1 can perform data communication with a construction company 12. In the construction company 12, a design landform of the construction site 3 is created. The design landform is a target shape of a land surface in the construction site 3. An information terminal 13 such as a personal computer is installed in the construction company 12. A worker Mb of the construction company 12 creates two-dimensional or three-dimensional design landform data using the information terminal 13.

In addition, the construction management system 1 can perform data communication with a support center 14 that supports the construction site 3. In the support center 14, a change of a design landform or generation of three-dimensional image data that has been requested by the construction site 3 is performed. An information terminal 15 such as a personal computer is installed in the support center 14. A worker Mc of the support center 14 performs works using the information terminal 15. In addition, the construction management system 1 may be disposed in the support center 14, and processing of the construction management system 1 may be executed in the support center 14.

[Construction Machine]

Next, the construction machine 4 will be described. An absolute position indicating a position of a vehicle main body of the construction machine 4 in the global coordinate system (XgYgZg-coordinate system) is detected by the Global Positioning System (GPS) including the GPS satellite 6. A relative position indicating a position of a blade edge of the work member with respect to the vehicle main body of the construction machine 4 in the local coordinate system (XYZ-coordinate system) is detected by a detection device provided in the construction machine 4. Based on the absolute position of the vehicle main body and the relative position between the vehicle main body and the blade edge of the work member, an absolute position of the blade edge of the work member is calculated.

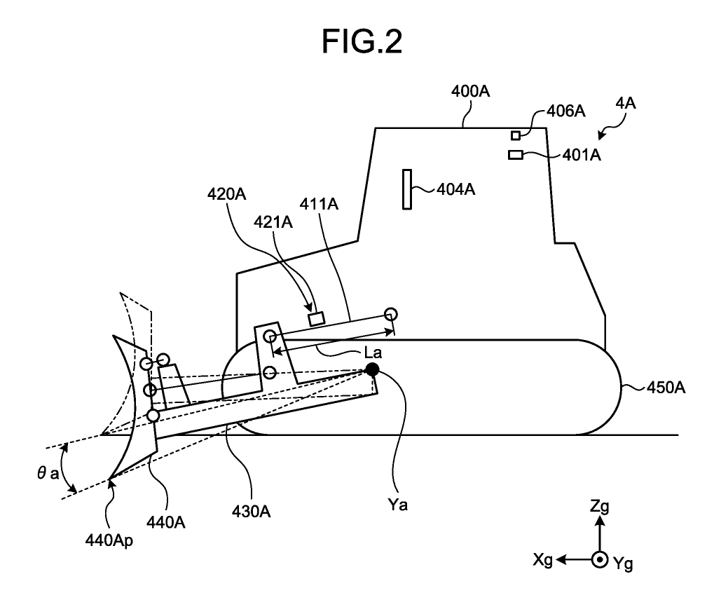

FIG. 2 is a diagram schematically illustrating the bulldozer 4A. The bulldozer 4A includes a vehicle main body 400A, a GPS receiver 406A that detects an absolute position of the vehicle main body 400A, a detection device 420A that detects a relative position of a blade edge 440Ap of a blade 440A with respect to the vehicle main body 400A, and a blade control device 401A that controls the position of the blade edge 440Ap of the blade 440A.

In addition, the bulldozer 4A includes a lift cylinder 411A being a hydraulic cylinder, a lift cylinder sensor 421A that detects an operation amount of the lift cylinder 411A, a lift frame 430A that supports the blade 440A, and a travel apparatus 450A that supports the vehicle main body 400A.

The vehicle main body 400A includes a cab provided with a driver seat on which a driver is seated. In the cab, various operating devices and an output device 404A that displays image data are disposed.

The travel apparatus 450A includes a crawler. The lift frame 430A is supported on the vehicle main body 400A so as to be vertically operable around an axis line Ya being parallel to a vehicle width direction. The blade 440A is supported on the vehicle main body 400A via the lift frame 430A. The lift cylinder 411A is provided so as to connect the vehicle main body 400A and the lift frame 430A. The lift cylinder 411A moves the lift frame 430A, and moves the blade 440A vertically. The blade edge 440Ap is disposed at a lower end portion of the blade 440A. In a land preparation work and an earth cutting work (excavation work), the blade edge 440Ap contacts the land surface of the construction site 3.

The GPS receiver 406A is provided in the vehicle main body 400A. The vehicle main body 400A is provided with a GPS antenna. The GPS antenna outputs, to the GPS receiver 406A, a signal corresponding to radiowaves received from the GPS satellite 6. The GPS receiver 406A acquires absolute position data indicating an absolute position of an own vehicle. By the GPS receiver 406A acquiring the absolute position of the own vehicle, the absolute position data indicating the absolute position of the vehicle main body 400A is acquired.

The detection device 420A includes the lift cylinder sensor 421A. The lift cylinder sensor 421A detects lift cylinder length data La indicating a stroke length of the lift cylinder 411A. Based on the lift cylinder length data La, the blade control device 401A calculates a lift angle θa of a blade 404A. The lift angle θa corresponds to an angle of descent from an origin position of the blade 440A, that is, a depth of penetration into the ground of the blade edge 440Ap, or a height from the ground. In FIG. 2, origin positions of the lift frame 430A and the blade 440A are indicated by dashed-two dotted lines. If the lift frame 430A and the blade 440A are positioned at the origin positions, the blade edge 440Ap of the blade 440A contacts the land surface. By the bulldozer 4A moving forward in a state in which the blade 440A is lowered from the origin position, the land preparation work and the earth cutting work (excavation work) are performed by the bulldozer 4A.

In addition, the bulldozer 4A may include an angle cylinder that can move the blade 440A in a rotation direction (an angle direction), a tilt cylinder that can move the blade 440A in a rotation direction (tilt direction), an angle cylinder sensor that detects angle cylinder length data indicating a stroke length of the angle cylinder, and a tilt cylinder sensor that detects tilt cylinder length data indicating a stroke length of the tilt cylinder, which are not illustrated in the drawing.

In addition to the lift cylinder sensor 421A, the detection device 420A also includes an angle cylinder sensor and a tilt cylinder sensor. The lift cylinder length data detected by the lift cylinder sensor 421A, the angle cylinder length data detected by the angle cylinder sensor, and the tilt cylinder length data detected by the tilt cylinder sensor are output to the blade control device 401A. Based on the lift cylinder length data, the angle cylinder length data, and the tilt cylinder length data, the blade control device 401A calculates a relative position of the blade edge 440Ap of the blade 440A with respect to the vehicle main body 400A. Based on the calculated relative position of the blade edge 440Ap of the blade 440A with respect to the vehicle main body 400A, and the absolute position of the vehicle main body 400A acquired by the GPS receiver 406A, the blade control device 401A calculates an absolute position of the blade edge 440Ap of the blade 440A.

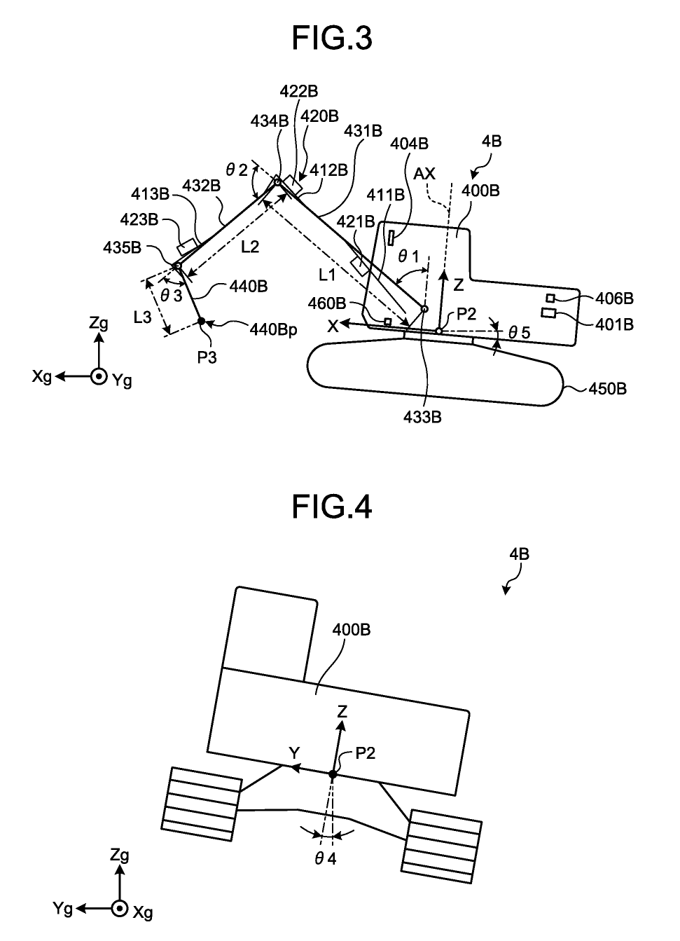

FIGS. 3 and 4 are diagrams schematically illustrating the excavator 4B. The excavator 4B includes a vehicle main body 400B, a GPS receiver 406B that detects an absolute position of the vehicle main body 400B, a detection device 420B that detects a relative position of a blade edge 440Bp of a bucket 440B with respect to the vehicle main body 400B, and a bucket control device 401B that controls a position of the blade edge 440Bp of the bucket 440B.

In addition, the excavator 4B includes a boom 431B connected to the vehicle main body 400B via a boom pin 433B, and an arm 432B connected to the boom 431B via an arm pin 434B. The bucket 440B is connected to the arm 432B via a bucket pin 435B.

In addition, the excavator 4B includes a boom cylinder 411B that drives the boom 431B, an arm cylinder 412B that drives the arm 432B, a bucket cylinder 413B that drives the bucket 440B, a boom cylinder stroke sensor 421B that detects an operation amount of the boom cylinder 411B, an arm cylinder stroke sensor 422B that detects an operation amount of the arm cylinder 412B, and a bucket cylinder stroke sensor 423B that detects an operation amount of the bucket cylinder 413B. The boom cylinder 411B, the arm cylinder 412B, and the bucket cylinder 413B are hydraulic cylinders.

In addition, the excavator 4B includes a travel apparatus 450B that supports the vehicle main body 400B, and an inertial measurement unit (IMU) 460B. The vehicle main body 400B is supported by the travel apparatus 450B. The vehicle main body 400B is an upper swing body that can swing around a swing axis AX. In addition, a point P2 indicated in FIGS. 3 and 4 is a point on the swing axis AX, and indicates an origin of the local coordinate system (XYZ-coordinate system).

The vehicle main body 400B includes a cab provided with a driver seat on which a driver is seated. In the cab, various operating devices and an output device 404B that displays image data are disposed.

The travel apparatus 450B includes a crawler. The blade edge 440Bp is disposed at a lower end portion of the bucket 440B. In the land preparation work and the earth cutting work (excavation work), the blade edge 440Bp contacts the land surface of the construction site 3.

The GPS receiver 406B is provided in the vehicle main body 400B. The vehicle main body 400B is provided with a GPS antenna. The GPS antenna outputs, to the GPS receiver 406B, a signal corresponding to radiowaves received from the GPS satellite 6. The GPS receiver 406B acquires absolute position data indicating an absolute position of an own vehicle. By the GPS receiver 406B acquiring the absolute position of the own vehicle, the absolute position data indicating the absolute position of the vehicle main body 400B is acquired.

The detection device 420B includes the boom cylinder stroke sensor 421B, the arm cylinder stroke sensor 422B, and the bucket cylinder stroke sensor 423B. The boom cylinder stroke sensor 421B detects boom cylinder length data indicating a stroke length of the boom cylinder 411B. The arm cylinder stroke sensor 422B detects arm cylinder length data indicating a stroke length of the arm cylinder 412B. The bucket cylinder stroke sensor 423B detects bucket cylinder length data indicating a stroke length of the bucket cylinder 413B.

Based on the boom cylinder length data, the bucket control device 401B calculates an inclination angle θ1 of the boom 431B with respect to a perpendicular direction of the vehicle main body 400B. Based on the arm cylinder length data, the bucket control device 401B calculates an inclination angle θ2 of the arm 432B with respect to the boom 431B. Based on the bucket cylinder length data, the bucket control device 401B calculates an inclination angle θ3 of the blade edge 440Bp of the bucket 440B with respect to the arm 432B. Based on the inclination angle θ1, the inclination angle θ2, the inclination angle θ3, a length L1 of the boom 431B, a length L2 of the arm 432B, and a length L3 of the bucket 440B, the bucket control device 401B calculates a relative position of the blade edge 440Bp of the bucket 440B with respect to the vehicle main body 400B. In addition, the length L1 of the boom 431B is a distance between the boom pin 433B and the arm pin 434B. The length L2 of the arm 432B is a distance between the arm pin 434B and the bucket pin 435B. The length L3 of the bucket 440 is a distance between the bucket pin 435B and the blade edge 440Bp of the bucket 440B.

The IMU 460B is provided in the vehicle main body 400B. The IMU 460B detects an inclination angle θ4 with respect to a left-right direction of the vehicle main body 400B, and an inclination angle θ5 with respect to a front-back direction of the vehicle main body 400B.

Based on the calculated relative position of the blade edge 440Bp of the bucket 440B with respect to the vehicle main body 400B, and the absolute position of the vehicle main body 400B that has been acquired by the GPS receiver 406B and the IMU 460B, the bucket control device 401B calculates an absolute position of the blade edge 440Bp of the bucket 440B.

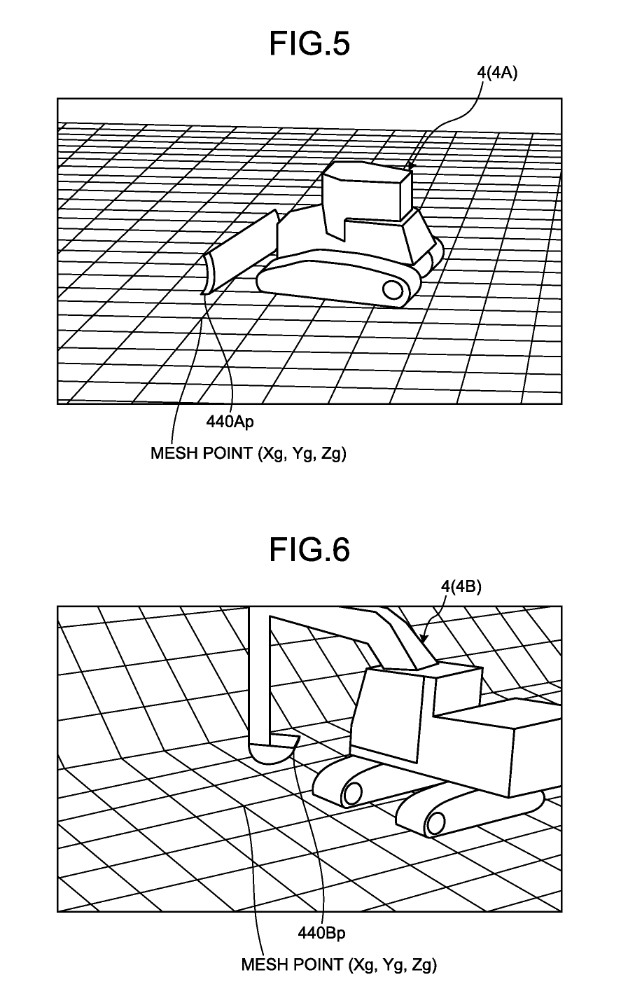

The construction machine 4 can acquire current landform data indicating a current landform of the land surface of the construction site 3. FIG. 5 is a schematic diagram illustrating a state in which the bulldozer 4A acquires current landform data, and FIG. 6 is a schematic diagram illustrating a state in which the excavator 4B acquires current landform data. As illustrated in FIG. 5, meshes are set in the current landform of the land surface of the construction site 3. The bulldozer 4A can detect an absolute position (a position in an Xg-axis direction, a position in a Yg-axis direction, and a position in a Zg-axis direction) of the blade edge 440Ap. By bringing the blade edge 440Ap into contact with a mesh point indicating an intersection point of meshes, the bulldozer 4A can acquire position data of each of a plurality of mesh points. Similarly, as illustrated in FIG. 6, by bringing the blade edge 440Bp into contact with a mesh point indicating an intersection point of meshes, the excavator 4B can acquire position data of each of a plurality of mesh points. By position data of a plurality of mesh points, that is, a trajectory of a blade edge 440p (the blade edge 440Ap, the blade edge 440Bp) being acquired, the current landform data of the construction site 3 is acquired. In addition, if the bulldozer 4A or the excavator 4B travels while driving a crawler track included in a travel apparatus 450 (450A, 450B), based on dimension information of a vehicle body, and absolute position data indicating an absolute position of an own vehicle that is obtained by a GPS receiver 406 (406A, 406B), a trajectory of positions at which the crawler track has contacted the land surface during the traveling (travel trajectory of crawler track) may be obtained, and the travel trajectory of the crawler track may be acquired as current landform data of the construction site 3.

In this manner, an absolute position of a vehicle main body 400 (the vehicle main body 400A, the vehicle main body 400B) of the construction machine 4 (the bulldozer 4A, the excavator 4B) is detected by the GPS receiver 406 (406A, 406B) mounted in the vehicle main body 400, and the GPS including the GPS satellite 6. In addition, the construction machine 4 includes a detection device 420 (the detection device 420A, the detection device 420B) that can detect a relative position of the blade edge 440p (the blade edge 440Ap, the blade edge 440Bp) of a work member 440 (the blade 440A, the bucket 440B) with respect to the vehicle main body 400. Based on the absolute position of the vehicle main body 400, and the relative position of the work member 440 with respect to the vehicle main body 400, the construction machine 4 can obtain an absolute position of the work member 440. The construction machine 4 can perform data communication with the computer system 2. The design landform data is transmitted from the computer system 2 to the construction machine 4. Based on the design landform data being a target shape of an excavation target, the construction machine 4 controls the work member 440 so that the blade edge 440p of the work member 440 moves in accordance with the design landform.

In addition, the construction machine 4 can acquire current landform data of the construction site 3 using the blade edge 440p. In addition, the construction machine 4 can acquire construction result data based on the absolute position of the blade edge 440p of the work member 440 during a work. The current landform data or the construction result data that has been acquired by the construction machine 4 is transmitted to the computer system 2.

[Drone]

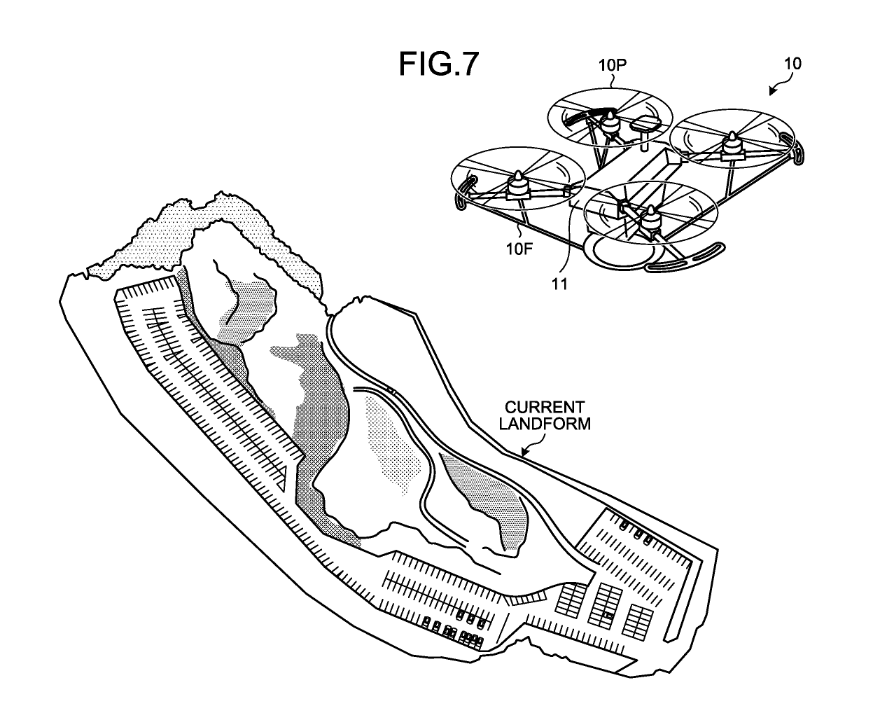

FIG. 7 is a diagram schematically illustrating the drone 10. The drone 10 is an unmanned air vehicle that can fly above the construction site 3. Measurement of the construction site 3 is performed by the drone 10. The drone 10 is an uninhabited helicopter including a propeller 10P. The drone 10 includes a frame member 10F, the camera 11 supported on the frame member 10F, and the propeller 10P provided on the frame member 10F. By the propeller 10P rotating, the drone 10 flies. The drone 10 may be a flight vehicle that automatically flies in accordance with a flight route while comparing a predetermined flight route and a current position of itself, or may be a flight vehicle that is remotely-manipulated according to a radio signal from a radio manipulation device held by a manipulator on the ground, and flies on a flight route intended by the manipulator. An image of a current landform of the construction site 3 is aerially taken by the camera 11 of the drone 10. Image data of the current landform that has been acquired by the camera 11 is stored in a storage device 102 to be described later. The image data stored in the storage device 102 is downloaded from the storage device 102 onto a computer on the ground in a wireless or wired manner. The image data downloaded onto the computer is converted by conversion software installed on the computer, into three-dimensional current landform data indicating a current landform of the construction site 3. The three-dimensional current landform data is thereby acquired. In addition, conversion software may be stored in the storage device 102 of the drone 10, and three-dimensional current landform data may be generated by a processor 101 included in the drone 10.

[Hardware Configuration]

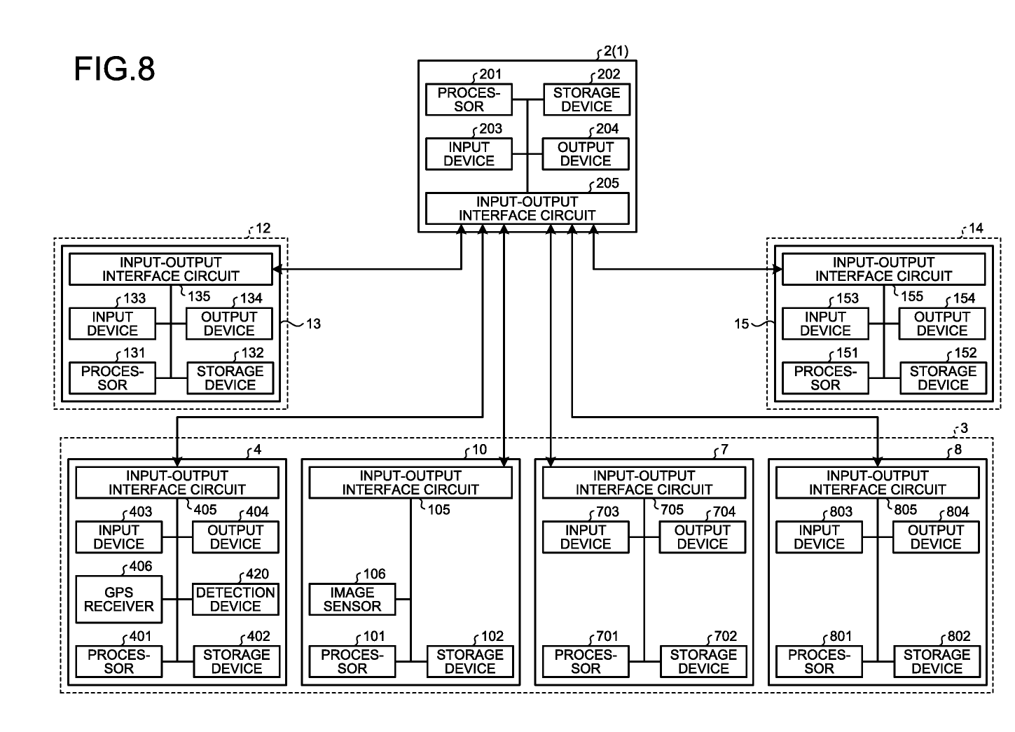

FIG. 8 is a diagram illustrating a hardware configuration of the construction management system 1. The computer system 2 of the construction management system 1 includes a processor 201 such as a central processing unit (CPU), a storage device 202 including an internal memory such as a read only memory (ROM) or a random access memory (RAM), and an external memory such as a hard disc device, an input device 203 including an input device such as a keyboard, a mouse, and a touch panel, an output device 204 including a display device such as a flat-panel display device, and a printing device such as an ink-jet printer, and an input-output interface circuit 205 including a wired communication device or a wireless communication device.

The information terminal 13 installed in the construction company 12 includes a processor 131, a storage device 132, an input device 133, an output device 134, and an input-output interface circuit 135 including a wired communication device or a wireless communication device.

The construction machine 4 operating in the construction site 3 includes a processor 401, a storage device 402, an input device 403, an output device 404, the GPS receiver 406, the detection device 420, and an input-output interface circuit 405 including a wired communication device or a wireless communication device.

The drone 10 operating in the construction site 3 includes the processor 101, the storage device 102, an image sensor 106 of the camera 11, and an input-output interface circuit 105 including a wired communication device or a wireless communication device.

The mobile terminal 7 used in the construction site 3 includes a processor 701, a storage device 702, an input device 703, an output device 704, and an input-output interface circuit 705 including a wired communication device or a wireless communication device.

The information terminal 8 installed in the construction site 3 includes a processor 801, a storage device 802, an input device 803, an output device 804, and an input-output interface circuit 805 including a wired communication device or a wireless communication device.

The information terminal 15 installed in a service center 14 includes a processor 151, a storage device 152, an input device 153, an output device 154, and an input-output interface circuit 155 including a wired communication device or a wireless communication device.

The computer system 2 can perform data communication with the construction machine 4 in the construction site 3, the transporter vehicle 5, the mobile terminal 7, the information terminal 8, and the drone 10. The mobile terminal 7 and the information terminal 8 perform data communication with the computer system 2 via the internet. The construction machine 4, the transporter vehicle 5, and the drone 10 wirelessly perform data communication with the computer system 2 via a communication satellite line or a mobile phone line. In addition, the construction machine 4, the transporter vehicle 5, and the drone 10 may wirelessly perform data communication with the computer system 2 using another communication form such as a wireless local area network (LAN) including Wi-Fi.

In addition, the computer system 2 performs data communication with the information terminal 13 of the construction company 12 via the internet. The computer system 2 performs data communication with the information terminal 15 of the support center 14 via the internet.

[Computer System]

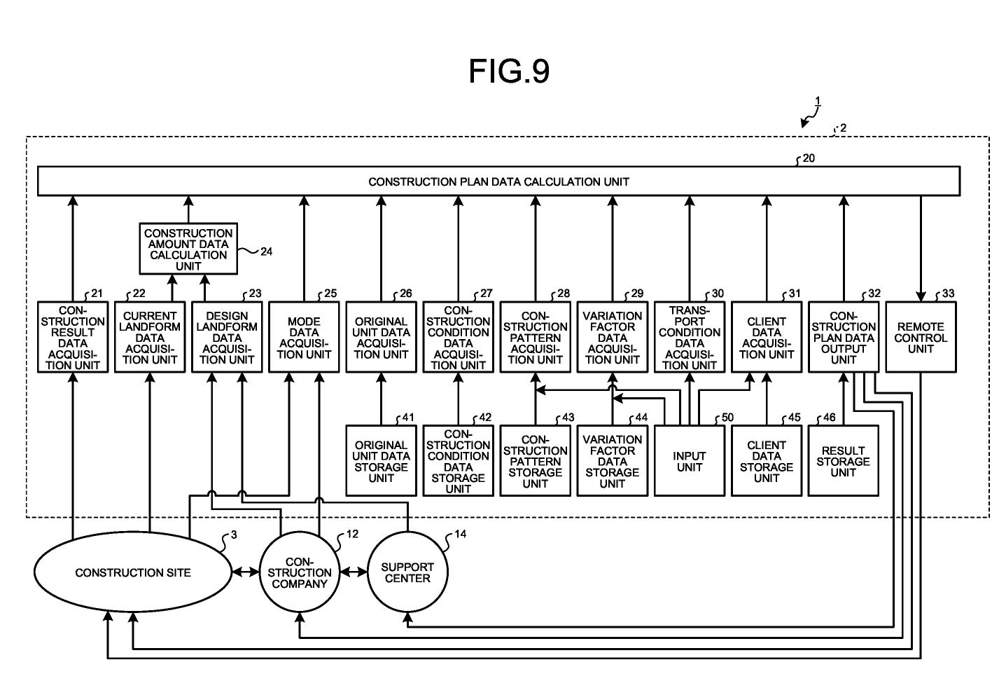

FIG. 9 is a functional block diagram illustrating the construction management system 1. The computer system 2 of the construction management system 1 includes a construction plan data calculation unit 20, a construction result data acquisition unit 21, a current landform data acquisition unit 22, a design landform data acquisition unit 23, a construction amount data calculation unit 24, a mode data acquisition unit 25, an original unit data acquisition unit 26, a construction condition data acquisition unit 27, a construction pattern acquisition unit 28, a variation factor data acquisition unit 29, a transport condition data acquisition unit 30, a client data acquisition unit 31, a construction plan data output unit 32, and a remote control unit 33.

In addition, the computer system 2 includes an original unit data storage unit 41, a construction condition data storage unit 42, a construction pattern storage unit 43, a variation factor data storage unit 44, a client data storage unit 45, and a result storage unit 46.

In addition, the computer system 2 includes an input unit 50 that generates, by being manipulated, an input signal corresponding to the manipulation.

The processor 201 handles functions of the construction plan data calculation unit 20, the construction result data acquisition unit 21, the current landform data acquisition unit 22, the design landform data acquisition unit 23, a construction amount data acquisition unit 24, the mode data acquisition unit 25, the original unit data acquisition unit 26, the construction condition data acquisition unit 27, the construction pattern acquisition unit 28, the variation factor data acquisition unit 29, the transport condition data acquisition unit 30, the client data acquisition unit 31, the construction plan data output unit 32, and the remote control unit 33.

The storage device 202 handles functions of the original unit data storage unit 41, the construction condition data storage unit 42, the construction pattern storage unit 43, the variation factor data storage unit 44, the client data storage unit 45, and the result storage unit 46.

The input device 203 handles a function of the input unit 50.

<Construction Result Data Acquisition Unit>

The construction result data acquisition unit 21 acquires construction result data indicating a construction result of the construction site 3. The construction result data is data indicating a result of construction executed by the construction machine 4. The construction machine 4 acquires construction result data of itself. Based on a trajectory of the absolute position of the blade edge 440p of the work member 440 that contacts the current landform, or a travel trajectory of the crawler, the construction machine 4 can detect the current landform. The construction machine 4 can compare the current landform detected from the absolute position of the blade edge 440p, and the design landform being a target shape, and acquire construction result data indicating how much a work (earth cutting or earth filling of sediment) has progressed with respect to the design landform. The construction result data acquisition unit 21 wirelessly acquires the construction result data from the construction machine 4. In addition, the computer system 2 may acquire construction result data by acquiring current landform data from the construction machine 4, and comparing the current landform and the design landform.

<Current Landform Data Acquisition Unit>

The current landform data acquisition unit 22 acquires current landform data indicating a current landform of the construction site 3. The current landform data is detected by the camera 11 provided in the drone 10. The current landform data acquisition unit 22 acquires the current landform data wirelessly, for example, from the camera 11 of the drone 10.

<Design Landform Data Acquisition Unit>

The design landform data acquisition unit 23 acquires design landform data indicating a design landform of the construction site 3. The design landform is created in the construction company 12. The design landform data acquisition unit 23 acquires the design landform data from the information terminal 13 of the construction company 12 via the internet. In addition, the design landform may be created in the support center 14. The design landform data acquisition unit 23 may acquire the design landform data from the information terminal 15 of the support center 14 via the internet.

<Construction Amount Data Calculation Unit>

Based on the current landform of the construction site 3 that has been acquired by the current landform data acquisition unit 22, and the design landform of the construction site 3 that has been acquired by the design landform data acquisition unit 23, the construction amount data calculation unit 24 calculates construction range data and construction amount data of the construction site 3.

The construction range refers to a range in which the current landform needs to be changed based on the design landform data. The construction range data is data indicating a range requiring construction that is derived from a difference between the current landform data and the design landform data. The construction range data includes at least either one of earth cutting portion data indicating a portion requiring earth cutting (excavation) of sediment in the construction range, and earth filling portion data indicating a portion requiring earth filling (charging) of sediment in the construction range.

The construction amount is a collective term of an earth cutting amount and an earth filling amount in the construction range. In the present embodiment, the construction amount refers to a summation of the earth cutting amount or the earth filling amount. The construction amount data is a collective term of earth cutting amount data and earth filling amount data.

The earth cutting amount refers to an excavation amount of sediment to be excavated in the construction range. The earth cutting amount data is data indicating an earth cutting amount of sediment in the construction range. The earth cutting amount data includes at least either one of earth cutting numerical data indicating an earth cutting amount of sediment using a numerical value, and earth cutting image data indicating an earth cutting amount of sediment using an image (icon or animation).

The earth filling amount refers to a charge amount of sediment to be input into the construction range. The earth filling amount data is data indicating an earth filling amount of sediment in the construction range. The earth filling amount data includes at least either one of earth filling numerical data indicating an earth filling amount of sediment using a numerical value, and earth cutting image data indicating an earth filling amount of sediment using an image (icon or animation).

<Mode Data Acquisition Unit>

The mode data acquisition unit 25 acquires mode data indicating a prioritized item of construction. The prioritized item of construction is selected by the worker Ma of the construction site 3 or the worker Mb of the construction company 12. The worker Ma inputs a prioritized item of construction by manipulating the input device 703 of the mobile terminal 7 or the input device 803 of the information terminal 8. The worker Mb inputs a prioritized item of construction by manipulating the input device 133 of the information terminal 13. The mode data acquisition unit 25 acquires mode data indicating a prioritized item of construction, via the internet, for example, from at least one of the mobile terminal 7, the information terminal 8, and the information terminal 13.

The mode data includes at least either one of construction period prioritizing mode data that prioritizes a period of construction, and cost prioritizing mode data that prioritizes a cost of construction. If construction is desired to be ended early, the worker Ma or the worker Mb selects a construction period as a prioritized item of construction, and manipulates the input device 703, the input device 803, or the input device 133. By the input device being manipulated, the construction period prioritizing mode data that prioritizes a period of construction is acquired by the mode data acquisition unit 25. On the other hand, construction is desired to be performed at low cost, the worker Ma or the worker Mb selects a cost as a prioritized item of construction, and manipulates an input device. By the input device being manipulated, the cost prioritizing mode data that prioritizes a cost of construction is acquired by the mode data acquisition unit 25.

<Original Unit Data Acquisition Unit>

The original unit data acquisition unit 26 acquires original unit data indicating a specific condition of a work device that can construct the construction site 3. The original unit data is stored in the original unit data storage unit 41. The original unit data acquisition unit 26 acquires the original unit data from the original unit data storage unit 41.

The specific condition of a work device includes at least one of a type of a work device that can construct the construction site 3, a vehicle rank of the work device, work ability of the work device, and the number of work devices. In addition, the specific condition of a work device includes a management state of a work device that can be procured.

The work ability of a work device includes a work amount of the work device that can be executed per unit time. The work amount of the work device that can be executed per unit time refers to an amount of sediment that can be moved by the work device per unit time. The work amount of the work device that can be executed per unit time is also referred to as a construction machine work original unit. If the work device is the bulldozer 4A, a work amount of the bulldozer 4A refers to an earth dozing amount (an amount of sediment that can be dozed) and an earth filling amount (an amount of sediment that can be banked) that can be executed by the bulldozer 4A per unit time. If the work device is the excavator 4B, a work amount of the excavator 4B refers to a loading amount (an amount that can be loaded onto the transporter vehicle 5), an earth cutting amount (amount that can be excavated), and an earth filling amount (an amount of sediment that can be banked) that can be executed by the excavator 4B per unit time. If the work device is the transporter vehicle 5, a work amount of the transporter vehicle 5 refers to an amount of sediment that can be transported by the transporter vehicle 5 per unit time.

A work amount of the construction machine 4 that can be executed per unit time depends on a size of the work member 440. If the size of the work member 440 is large, the work amount becomes larger, and if the size of the work member 440 is small, the work amount becomes smaller. Thus, the work amount of a work device 4 includes the size of the work member 440. The work amount of the bulldozer 4A includes a size of the blade 440A, and the work amount of the excavator 4B includes a size (bucket capacity) of the bucket 440B.

In addition, the original unit data further includes a specific condition of the worker Ma of the construction site 3. The condition of the worker Ma includes the number of workers Ma that can be procured for the construction site 3. In addition, the specific condition of the worker Ma includes skills of the workers Ma that can be procured.

In other words, the original unit data includes data indicating resources necessary for construction, such as a specific condition of a work device and a specific condition of workers. The original unit data is known data that can be acquired before construction, is compiled as a database, and is stored in the original unit data storage unit 41.

<Construction Condition Data Acquisition Unit>

The construction condition data acquisition unit 27 acquires construction condition data indicating a construction condition of the construction site 3. The construction condition includes items to be set in the construction company 12. The construction condition data is stored in the construction condition data storage unit 42. The construction condition data acquisition unit 27 acquires the construction condition data from the construction condition data storage unit 42.

The construction condition data includes at least one of a budget related to construction, a construction period, work content, a work procedure, a work time, and a site environment. The site environment includes at least one of a landform of the construction site 3, and a size of the construction site 3. The construction condition data is known data set before construction, and is stored in the construction condition data storage unit 42.

<Construction Pattern Acquisition Unit>

The construction pattern acquisition unit 28 acquires a construction pattern of a work device. The construction pattern of the work device includes a use condition of the work device that is patterned in advance. The construction pattern includes use conditions of the construction machine 4 and the transporter vehicle 5 that are to be set when a certain work is executed. The use conditions of the construction machine 4 and the transporter vehicle 5 include a combination condition of the construction machine 4 and the transporter vehicle 5. A plurality of construction patterns is compiled as a database, and is stored in the construction pattern storage unit 43. A plurality of construction patterns for the earth filling work, and a plurality of construction patterns for the earth cutting work are at least stored in the construction pattern storage unit 43. A first earth filling pattern of executing the earth filling work using the construction machine 4 and the transporter vehicle 5 under a first use condition, a second earth filling pattern of executing the earth filling work using the construction machine 4 and the transporter vehicle 5 under a second use condition different from the first use condition, . . . , and an nth earth filling pattern of executing the earth filling work using the construction machine 4 and the transporter vehicle 5 under an nth use condition are stored in the construction pattern storage unit 43 for the earth filling work. In addition, a first earth cutting pattern of executing the earth cutting work using the construction machine 4 and the transporter vehicle 5 under the first use condition, a second earth cutting pattern of executing the earth cutting work using the construction machine 4 and the transporter vehicle 5 under the second use condition different from the first use condition, . . . , and an nth earth cutting pattern of executing the earth cutting work using the construction machine 4 and the transporter vehicle 5 under the nth use condition are stored in the construction pattern storage unit 43 for the earth cutting work.

By the input unit 50 being manipulated, a specific construction pattern corresponding to an input signal of the input unit 50 is selected from among the plurality of construction patterns stored in the construction pattern storage unit 43. The construction pattern acquisition unit 28 acquires, among the plurality of construction patterns stored in the construction pattern storage unit 43, the construction pattern selected according to the input signal of the input unit 50.

<Variation Factor Data Acquisition Unit>

The variation factor data acquisition unit 29 acquires variation factor data indicating a variation factor of the construction site 3. The variation factor data includes a variation factor such as a natural environment of the construction site 3, and affects work efficiency of construction. The variation factor data is stored in the variation factor data storage unit 44. In addition, the variation factor data is input by the input unit 50. The variation factor data acquisition unit 29 acquires the variation factor data from at least either one of the input unit 50 and the variation factor data storage unit 44.

The variation factor data includes soil property data indicating a type and a state of sediment in the construction site 3. In addition, the variation factor data includes buried object data indicating an underground buried object of the construction site 3. In addition, the variation factor data includes weather data of the construction site 3. The soil property data and the buried object data are acquired from a preliminary survey executed before construction. As a preliminary survey, a boring survey is exemplified. The weather data is acquired from a Meteorological Office or meteorological companies. The variation factor data acquired before construction is held in the variation factor data storage unit 44. In addition, the variation factor data acquired before construction is input from the input unit 50.

<Transport Condition Data Acquisition Unit>

The transport condition data acquisition unit 30 acquires transport condition data of the transporter vehicle 5. The transport condition data includes at least either one of a travel condition of the transporter vehicle 5 and a condition of a loaded object to be transported by the transporter vehicle 5. The travel condition of the transporter vehicle 5 includes at least one of an on-site average transport distance indicating an average value per unit time (e.g., per day) of travel distances for which the transporter vehicle 5 travels in the construction site 3 in a state in which sediment is loaded, a surplus soil conveyance average transport distance indicating an average value of travel distances for which the transporter vehicle 5 travels when conveying surplus soil generated in the construction site 3, to a surplus soil storage place provided on the outside of the construction site 3, and a bought soil conveyance average transport distance indicating an average value of travel distances for which the transporter vehicle 5 travels when conveying new sediment from a borrow pit provided on the outside of the construction site 3, to the construction site 3. The condition of the loaded object to be transported by the transporter vehicle 5 includes at least either one of a conveyed sediment type indicating a type (soil property) of sediment to be conveyed by the transporter vehicle 5 from the outside of the construction site 3, and an earth cutting sediment type indicating a type (soil property) of sediment to be excavated in the construction site 3 and conveyed by the transporter vehicle 5. The transport condition data is input from the input unit 50.

<Client Data Acquisition Unit>

The client data acquisition unit 31 acquires client data indicating a work device owned by a client. In the present embodiment, a person who owns the construction management system 1 including the computer system 2 is a supplier (vendor), and a person who constructs the construction site 3, and a person who performs works in the construction company 12 are clients (clients). The client accepts, from the supplier, a service as to construction management, construction planning, or the like. Before construction of the construction site 3, the client owns a work device in some cases. In other cases, the client owns no work device. The client data includes data indicating whether the client owns a work device. In addition, if the client owns a work device, the client data includes at least one of a type of the work device owned by the client, a vehicle rank of the work device, work ability of the work device, and the number of work devices.

The client data is known data that can be acquired before construction, is compiled as a database, and is stored in the client data storage unit 45. The client data acquisition unit 31 acquires the client data from the client data storage unit 45. In addition, the client data may be input from the input unit 50, and the client data acquisition unit 31 may acquire the client data from the input unit 50.

<Construction Plan Data Calculation Unit>

Based on the construction amount data calculated by the construction amount data calculation unit 24 based on a current landform and a design landform of a construction site 2, and the original unit data acquired by the original unit data acquisition unit 26, the construction plan data calculation unit 20 calculates construction plan data indicating a construction plan of the construction site 3. In the present embodiment, based on the construction amount data and the original unit data, the construction plan data calculation unit 20 calculates, for each of a plurality of target construction periods, a construction plan, and a construction cost required when construction is executed using the construction plan.

In the present embodiment, based on the construction amount data, the original unit data, and the construction patterns acquired by the construction pattern acquisition unit 28, the construction plan data calculation unit 20 calculates a plurality of construction plans respectively corresponding to a plurality of target construction periods, and calculates construction costs required when construction is executed using the plurality of respective calculated construction plans, in association with the plurality of construction plans.

In addition, based on the construction amount data, the original unit data, the construction patterns, and the transport condition data acquired by the transport condition data acquisition unit 30, the construction plan data calculation unit 20 calculates a plurality of construction plans respectively corresponding to a plurality of target construction periods, and calculates construction costs required when construction is executed using the plurality of respective calculated construction plans, in association with the plurality of construction plans.

The construction plan data calculated by the construction plan data calculation unit 20 includes at least one of planned work device data indicating a type of a work device to be used in the construction site 3, a vehicle rank of the work device, work ability of the work device, and the number of work devices, process sheet data indicating a process sheet of construction that uses the work devices, and cost data indicating a cost required for construction. The process sheet includes at least either one of a work procedure of construction, and a work time of each work of construction.

In addition, if construction condition data is acquired by the construction condition data acquisition unit 27, the construction plan data calculation unit 20 calculates construction plan data based on construction amount data, original unit data, and construction condition data.

In addition, if variation factor data is acquired by the variation factor data acquisition unit 29, the construction plan data calculation unit 20 calculates construction plan data based on construction amount data, original unit data, and variation factor data.

In addition, if mode data is acquired by the mode data acquisition unit 25, the construction plan data calculation unit 20 calculates construction plan data based on construction amount data, original unit data, and mode data.

In addition, if construction result data is acquired by the construction result data acquisition unit 21, the construction plan data calculation unit 20 recalculates construction plan data based on construction result data.

In addition, the construction plan data calculation unit 20 calculates construction plan data for each work of construction. In addition, the construction plan data calculation unit 20 calculates construction plan data for each construction day.

Construction plan data is calculated based on construction amount data calculated from a current landform and a design landform, and original unit data. As mentioned above, the original unit data indicates a specific condition including work ability or the like of the work device. In other words, original unit data indicates work ability of a work device that can be input to a construction site. Based on an earth cutting portion and an earth cutting amount from a current landform, and original unit data indicating ability of a work device, the construction plan data calculation unit 20 can estimate a work device having which type, vehicle rank, or work ability is input, and how many work devices are input, and how much time is required for completion of the earth cutting work in this case. Similarly, based on an earth filling portion and an earth filling amount to a current landform, and original unit data indicating ability of a work device, the construction plan data calculation unit 20 can estimate a work device having which type, vehicle rank, or work ability is input, and how many work devices are input, and how much time is required for completion of the earth filling work in this case. Thus, based on construction amount data calculated from current landform data acquired by the current landform data acquisition unit 22 and design landform data acquired by the design landform data acquisition unit 23, and original unit data acquired by the original unit data acquisition unit 26, the construction plan data calculation unit 20 can calculate a time and a cost required for completing a specific work (earth cutting work or earth filling work) if a specific work device derived from the original unit data is used.

In addition, by calculating a construction plan using not only construction amount data and original unit data, but also a construction pattern, simulation accuracy of construction is enhanced. By the construction pattern being identified, the number of work devices used and work content of the work devices are determined. If a specific work is executed in a specific construction pattern using a work device derived from original unit data, a time and a cost required until the end of the work can be estimated. Thus, based on construction amount data, original unit data, and a construction pattern, the construction plan data calculation unit 20 can highly-accurately calculate a time and a cost required until the completion of a specific work if a specific work device derived from original unit data is used in a specific construction pattern.

In addition, by calculating a construction plan using not only construction amount data, original unit data, and a construction pattern, but also transport condition data, simulation accuracy of construction is further enhanced. A work time varies depending on a transport condition of the transporter vehicle 5. Thus, by a transport condition of the transporter vehicle 5 being identified by transport condition data acquired by the transport condition data acquisition unit 30, the construction plan data calculation unit 20 can highly-accurately calculate a time and a cost required until the completion of a specific work, based on construction amount data, original unit data, a construction pattern, and transport condition data.

In addition, the construction plan data calculation unit 20 calculates a work procedure of construction based on a current landform and a design landform. For example, if earth filling is performed on a portion requiring earth filling, if earth filling can be executed using cut earth in a construction range, without transporting sediment from the outside of the construction site 3, the construction plan data calculation unit 20 calculates a work procedure so that earth filling is executed using cut earth existing at a position having higher height (altitude) than the portion requiring earth filling. By calculating a work procedure so that sediment is transported from a high position to a low position, work burden is reduced, and work efficiency is enhanced.

In addition, in the present embodiment, based on construction plan data calculated based on current landform data of the construction site and design landform data of the construction site and original unit data of a work device, and client data, the construction plan data calculation unit 20 calculates necessary work device data indicating a work device necessary for executing construction of the construction site 3 using the calculated construction plan. The construction plan data includes planned work device data indicating a type of a work device to be used in the construction site 3, a vehicle rank of the work device, work ability of the work device, and the number of work devices. The planned work device data indicates a work device (type, vehicle rank, work ability, and the number of work devices) necessary for completing construction of the construction site 3 within a target construction period and a target cost. Thus, the necessary work device data includes the planned work device data.

In addition, the necessary work device data indicates a work device that a client needs to newly procure. If the client owns all work devices indicated by the planned work device data calculated by the construction plan data calculation unit 20, the client needs not newly procure a work device. The client executes construction using work devices owned by itself, according to a construction plan calculated by the construction plan data calculation unit 20. On the other hand, if the client does not own or owns only a part of the work devices indicated by the planned work device data calculated by the construction plan data calculation unit 20, the client needs to newly procure a deficient work device. The necessary work device data includes data indicating a work device determined to be deficient for executing construction according to the calculated construction plan, and determined to be in need of being newly procured. If work devices owned by the client are part of work devices indicated by the planned work device data, by compensating for a deficient work device with a newly-procured work device, the client can execute construction using the owned work devices and the newly-procured work device, according to the construction plan calculated by the construction plan data calculation unit 20. In addition, if the client does not own at all the work devices indicated by the planned work device data, by newly procuring all of the work devices indicated by the planned work device data, the client can execute construction using the newly-procured work devices, according to the construction plan calculated by the construction plan data calculation unit 20. In this manner, by calculating data indicating a work device determined to be deficient in the execution of construction, the client can execute construction according to a construction plan data.

In the present embodiment, for each of a plurality of target construction periods, a construction plan and a construction cost required when construction is executed using the construction plan are calculated. Construction plan data calculated by the construction plan data calculation unit 20 includes a construction plan calculated for each of a plurality of target construction periods, and a construction cost required when construction is executed using the construction plan. In the present embodiment, based on construction plan data calculated for each of a plurality of target construction periods, and client data, the construction plan data calculation unit 20 calculates necessary work device data for each of the plurality of target construction periods.

In addition, as mentioned above, in the present embodiment, by the input unit 50 being manipulated, a specific construction pattern corresponding to an input signal of the input unit 50 is selected from among the plurality of construction patterns of a work device that are stored in the construction pattern storage unit 43. Based on the selected specific construction pattern, and client data, the construction plan data calculation unit 20 calculates necessary work device data.

<Construction Plan Data Output Unit>

The construction plan data output unit 32 outputs a construction plan calculated by the construction plan data calculation unit 20. The construction plan data output unit 32 outputs construction plan data to the result storage unit 46.

In addition, the construction plan data output unit 32 outputs, via the internet, the construction plan calculated by the construction plan data calculation unit 20, to at least one of the mobile terminal 7, the information terminal 8 provided in the construction site 3, the information terminal 13 provided in the construction company 12, and the information terminal 15 provided in the support center 14.

In addition, the construction plan data output unit 32 outputs, via the internet, the necessary work device data calculated by the construction plan data calculation unit 20, to at least one of the mobile terminal 7, the information terminal 8, the information terminal 13, and the information terminal 15.

The output device 704 of the mobile terminal 7, the output device 804 of the information terminal 8, the output device 134 of the information terminal 13, and the output device 154 of the information terminal 15 function as output devices that can output construction plan data and necessary work device data.

The output device 704 of the mobile terminal 7, the output device 704 of the information terminal 8, the output device 134 of the information terminal 13, and the output device 154 of the information terminal 15 include display devices that can display image data. The output device 704, the output device 804, the output device 134, and the output device 154 include flat-panel displays such as a liquid crystal display, for example. The mobile terminal 7, the information terminal 8, the information terminal 13, and the information terminal 15 convert construction plan data and necessary work device data, into image data, and display the image data on the output device 704, the output device 804, the output device 134, and the output device 154.

In addition, the output device 704, the output device 804, the output device 134, and the output device 154 may include printing devices that print construction plan data on a medium such as a paper medium. The output device 704, the output device 804, the output device 134, and the output device 154 may include print devices such as an ink-jet printer, for example.

The construction plan data output unit 32 outputs, to the output devices 704, 804, 134, and 154, output data to be output by the output devices 704, 804, 134, and 154, together with a command signal commanding an output format. The construction plan data output unit 32 designates an output format of output data to be output by the output devices 704, 804, 134, and 154, by outputting a command signal to the output devices 704, 804, 134, and 154. The output devices 704, 804, 134, and 154 output the output data based on the output format designated by the construction plan data output unit 32.

In the following description, the output device 704, the output device 804, the output device 134, and the output device 154 are assumed to be display devices, and the output device 704 of the mobile terminal 7 will be appropriately referred to as a display device 704, the output device 804 of the information terminal 8 will be appropriately referred to as a display device 804, the output device 134 of the information terminal 13 will be appropriately referred to as a display device 134, and the output device 154 of the information terminal 15 will be appropriately referred to as a display device 154. Output performed by the output devices includes display performed by the display devices.

The construction plan data output unit 32 outputs, to the display devices 704, 804, 134, and 154, display data to be displayed by the display devices 704, 804, 134, and 154, together with a command signal commanding a display format. The construction plan data output unit 32 designates a display format of display data to be displayed by the display devices 704, 804, 134, and 154, by outputting a command signal to the display devices 704, 804, 134, and 154. The display devices 704, 804, 134, and 154 display the display data based on the display format designated by the construction plan data output unit 32.

Current landform data acquired by the camera 11 of the drone 10, and design landform data created in the construction company 12 are output to the mobile terminal 7, the information terminal 8, the information terminal 13, and the information terminal 15 via the construction plan data calculation unit 20 and the construction plan data output unit 32. The construction plan data calculation unit 20 processes the acquired current landform data and design landform data into three-dimensional image data. In other words, the construction plan data calculation unit 20 converts image data of a current landform that has been acquired by the camera 11, into three-dimensional image data. In addition, the construction plan data calculation unit 20 converts two-dimensional design landform data or three-dimensional design landform data being a design drawing that has been created in the construction company 12, into three-dimensional image data. The construction plan data calculation unit 20 outputs, via the construction plan data output unit 32, three-dimensional image data of current landform data and design landform data to the mobile terminal 7, the information terminal 8, the information terminal 13, and the information terminal 15.

The construction plan data output unit 32 outputs current landform data and design landform data as display data, and outputs a three-dimensional display command signal as a command signal designating a display format. The construction plan data output unit 32 designates a display format of the display devices 704, 804, 134, and 154 so that current landform data and design landform data are three-dimensionally displayed. The display device 704 of the mobile terminal 7, the display device 804 of the information terminal 8, the display device 134 of the information terminal 13, and the display device 154 of the information terminal 15 three-dimensionally display current landform data and design landform data based on the display format designated by the construction plan data output unit 32.

In addition, the construction plan data output unit 32 can designate a display format of the display devices 704, 804, 134, and 154 so that current landform data and design landform data are displayed not only in a three-dimensional image format but also in a display format of at least one of a two-dimensional image format, a numerical format, a character format, and a table format.

In addition, construction result data acquired by the construction machine 4 is output, via the construction plan data calculation unit 20 and the construction plan data output unit 32, to the mobile terminal 7, the information terminal 8, the information terminal 13, and the information terminal 15. The mobile terminal 7, the information terminal 8, the information terminal 13, and the information terminal 15 function as second output devices that can output construction result data. The construction plan data calculation unit 20 processes the construction result data acquired by the construction machine 4, into three-dimensional image data. In other words, the construction plan data calculation unit 20 converts position data of each of a plurality of mesh points acquired by the construction machine 4, into three-dimensional image data. The construction plan data calculation unit 20 outputs, via the construction plan data output unit 32, the construction result data to the mobile terminal 7, the information terminal 8, the information terminal 13, and the information terminal 15.

The construction plan data output unit 32 outputs construction result data as display data, and outputs a three-dimensional display command signal as a command signal designating a display format. The construction plan data output unit 32 designates a display format of the display devices 704, 804, 134, and 154 so that construction result data is three-dimensionally displayed. The display device 704 of the mobile terminal 7, the display device 804 of the information terminal 8, the display device 134 of the information terminal 13, and the display device 154 of the information terminal 15 three-dimensionally display construction result data based on the display format designated by the construction plan data output unit 32.

In addition, the construction plan data output unit 32 can designate a display format of the display devices 704, 804, 134, and 154 so that construction result data is displayed not only in a three-dimensional image format but also in a display format of at least one of a two-dimensional image format, a numerical format, a character format, and a table format.

In the present embodiment, the construction plan data output unit 32 causes the output devices 704, 804, 134, and 154 to output construction costs corresponding to a plurality of target construction periods. The construction plan data output unit 32 causes the output devices 704, 804, 134, and 154 to output (display) target construction periods and construction costs that respectively correspond to a plurality of construction plans calculated by the construction plan data calculation unit 20.

The construction plan data output unit 32 causes the output devices 704, 804, 134, and 154 to output the plurality of target construction periods in association with the construction costs, and causes the output devices 704, 804, 134, and 154 to output a construction plan corresponding to a target construction period selected according to an input signal of the input unit 50, among the plurality of target construction periods output by the output devices 704, 804, 134, and 154.

The construction plan data output unit 32 causes the output devices 704, 804, 134, and 154 to output points indicating construction plans respectively corresponding to a plurality of target construction periods, in a graph in which a first axis indicating a target construction period and a second axis indicating a construction cost are defined, and causes the output devices 704, 804, 134, and 154 to output a construction plan corresponding to a selected point among the plurality of points.

<Remote Control Unit>

In addition, the computer system 2 includes the remote control unit 33 that outputs a control signal for remotely manipulating the construction machine 4, based on design landform data. The remote control unit 33 remotely controls the construction machine 4. If a design landform is changed according to a demand from the construction site 3, the remote control unit 33 outputs a control signal for remotely manipulating the construction machine 4, based on the changed design landform data.

[Support Center]

The information terminal 15 of the support center 14 can execute a function equivalent to the construction plan data calculation unit 20 of the computer system 2. For example, the information terminal 15 can execute generation of three-dimensional image data that can be executed by the construction plan data calculation unit 20. In place of the construction plan data calculation unit 20, the information terminal 15 can process construction result data acquired from the construction machine 4, into three-dimensional image data, and can convert two-dimensional design landform data or three-dimensional design landform data being a design drawing that has been created in the construction company 12, into three-dimensional image data. The generated three-dimensional image data is transmitted to the mobile terminal 7 and the information terminal 8 via the input-output interface circuit 155 and the computer system 2.

In addition, the support center 14 accepts a change of a design landform that has been demanded from the construction site 3. In the support center 14, design landform data indicating a changed design landform is calculated using the information terminal 15. The information terminal 15 transmits the changed design landform data to the computer system 2 via the internet, for example. The design landform data acquisition unit 23 of the computer system 2 acquires the changed design landform data output from the support center 14. The construction plan data calculation unit 20 recalculates construction plan data based on the changed design landform data.

The changed design landform data is transmitted to the construction machine 4. The work member 440 is controlled based on the changed design landform data.

[Construction Management Method]

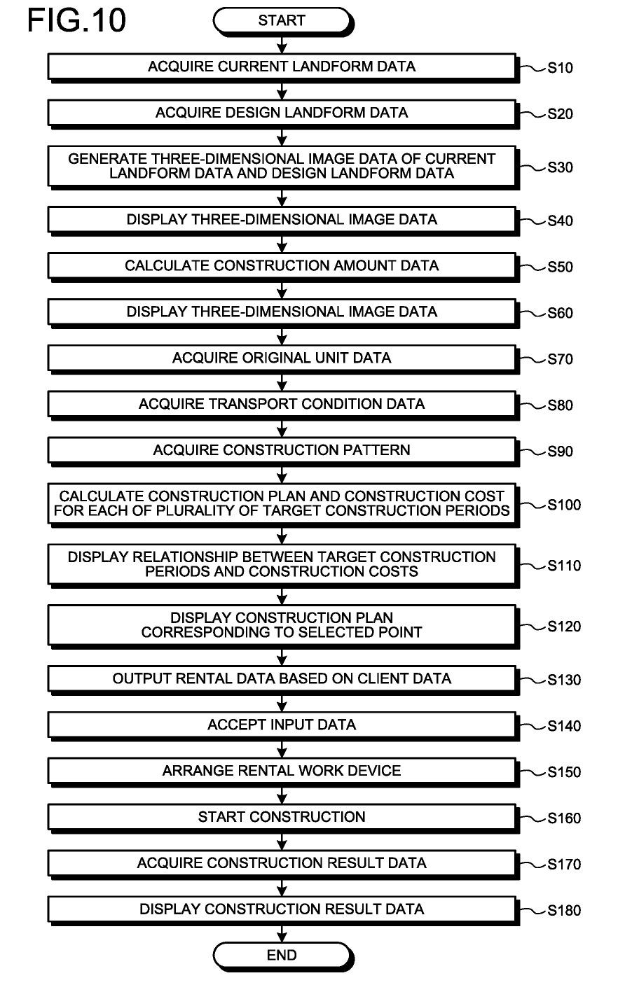

Next, a construction management method that uses the construction management system 1 will be described. FIG. 10 is a flowchart illustrating a construction planning method.

As described above, the construction plan data output unit 32 of the computer system 2 causes the display device 704 of the mobile terminal 7, the display device 804 of the information terminal 8, the display device 134 of the information terminal 13, and the display device 154 of the information terminal 15 to output (display), to the mobile terminal 7, the information terminal 8, the information terminal 13, and the information terminal 15, target construction periods and construction costs that respectively correspond to a plurality of construction plans calculated by the construction plan data calculation unit 20. In the following description, for simplifying the description, the construction plan data output unit 32 is assumed to cause the display device 704 of the mobile terminal 7 to display target construction periods and construction costs that respectively correspond to a plurality of construction plans.

Measurement of the construction site 3 is performed using the drone 10. The camera 11 of the drone 10 acquires three-dimensional current landform data of the construction site 3. The current landform data acquisition unit 22 acquires current landform data from the camera 11 (Step S10).

In addition, design landform data is acquired by the design landform data acquisition unit 23 (Step S20).

The construction plan data calculation unit 20 generates three-dimensional image data of current landform data and three-dimensional image data of design landform data (Step S30).

The three-dimensional image data of current landform data and the three-dimensional image data of design landform data are transmitted to the mobile terminal 7. The three-dimensional image data of current landform data and the three-dimensional image data of design landform data are displayed on the display device 704 of the mobile terminal 7 (Step S40).

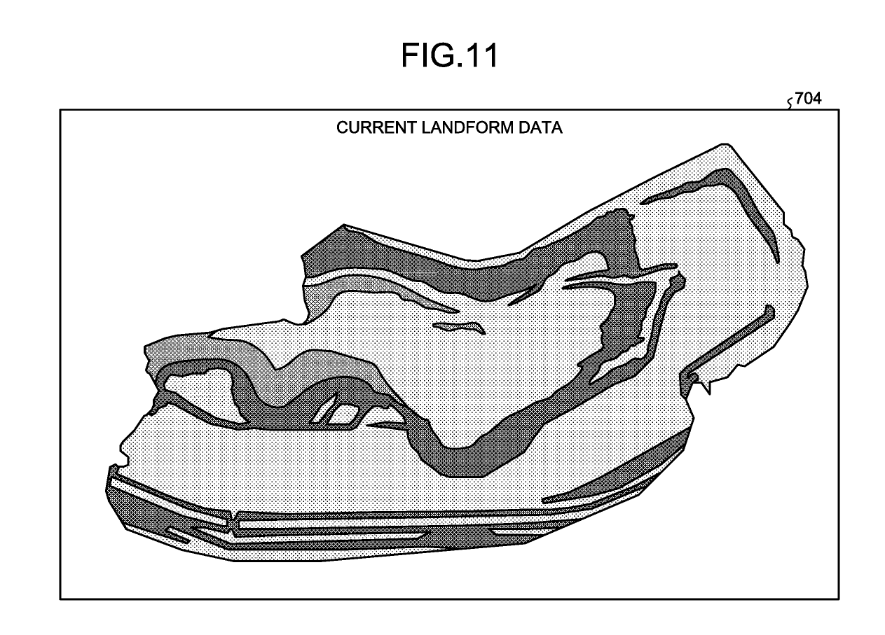

FIG. 11 is a diagram illustrating a display example of the three-dimensional image data of current landform data that is caused by the display device 704. The construction plan data output unit 32 causes the display device 704 to three-dimensionally display current landform data. The display device 704 displays a plurality of portions of a current landform in different designs (colors or patterns). In the example illustrated in FIG. 11, the current landform is discretely divided into a plurality of portions based on the altitude of the current landform. A portion at an altitude in a first range is displayed in a first design, a portion at an altitude in a second range being different in altitude from the first range is displayed in a second design, and a portion at an altitude in an Nth range is displayed in an Nth design. Here, N is a natural number equal to or larger than 3.

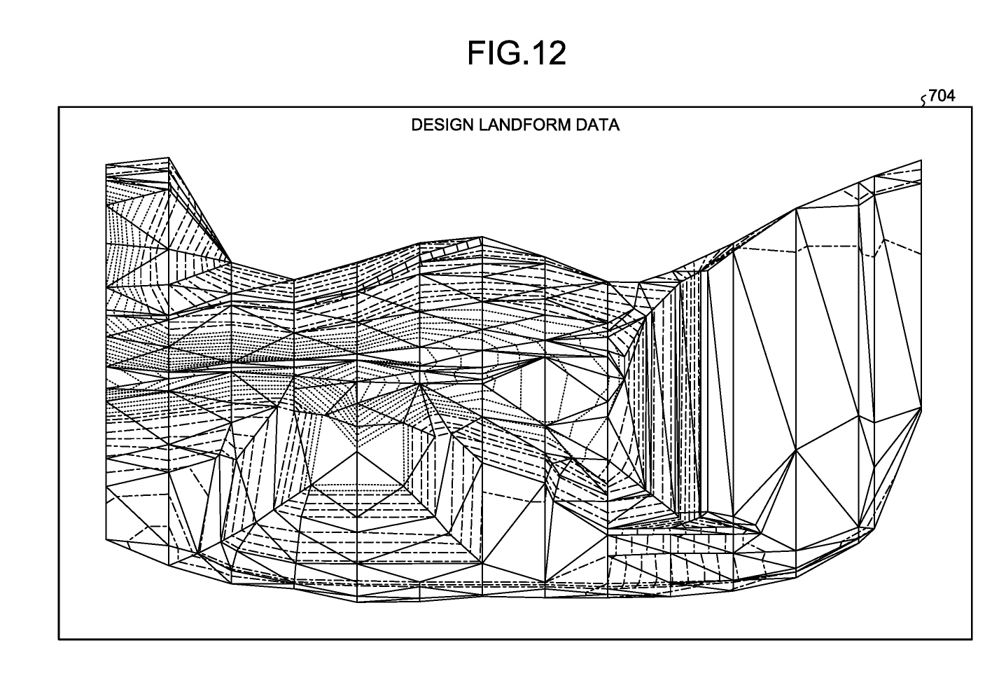

FIG. 12 is a diagram illustrating a display example of the three-dimensional image data of design landform data that is caused by the display device 704. For example, a shape of a design landform is displayed as three-dimensional image data using polygon display. A construction plan data output unit 28 causes the display device 704 to three-dimensionally display the design landform data. The display device 704 displays a design landform being a target shape obtainable after construction, using a plurality of lines.

The construction amount data calculation unit 24 calculates construction amount data of the construction site 3 based on current landform data acquired by the current landform data acquisition unit 22, and design landform data acquired by the design landform data acquisition unit 23 (Step S50).

The construction plan data calculation unit 20 calculates three-dimensional image data of construction amount data, and transmits the three-dimensional image data to the mobile terminal 7 via the construction plan data output unit 32. The display device 704 of the mobile terminal 7 displays three-dimensional image data of construction range data and construction amount data (Step S60).

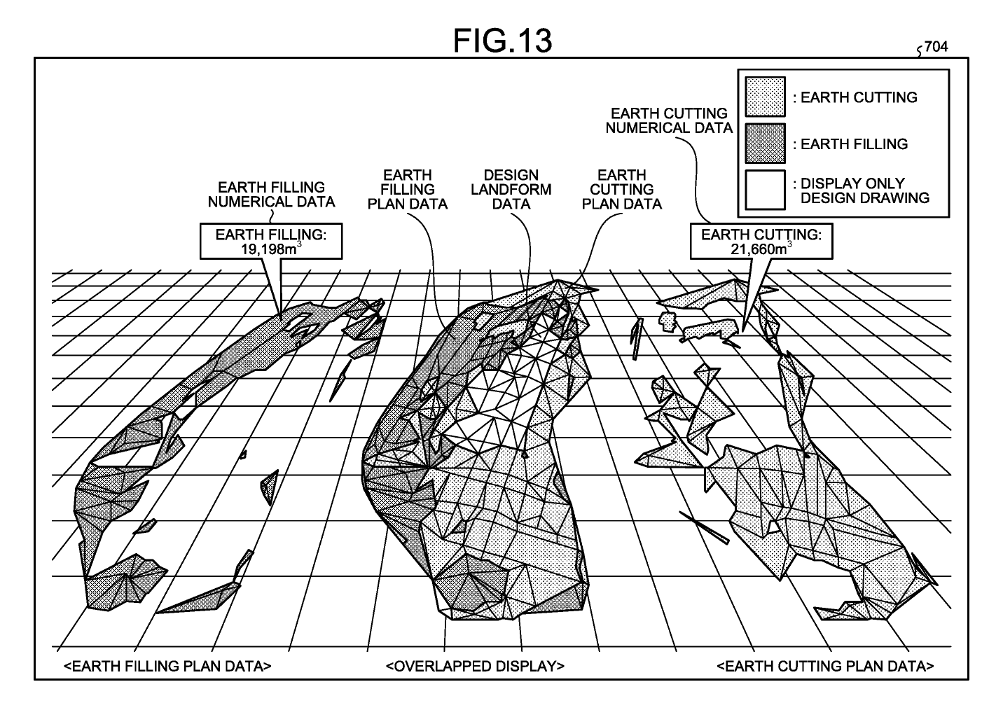

FIG. 13 is a diagram illustrating a display example of design landform data and construction amount data that is caused by the display device 704. The construction amount data includes earth cutting portion data of earth cutting plan data, earth cutting numerical data of the earth cutting plan data, earth filling portion data of earth filling plan data, and earth filling numerical data of the earth filling plan data. As illustrated in FIG. 13, the construction plan data output unit 32 causes the display device 704 to three-dimensionally display, side by side, the earth cutting plan data (earth cutting portion data) and the earth filling plan data (earth filling portion data) in a construction range. The design landform data, the earth cutting plan data (earth cutting portion data), and the earth filling plan data (earth filling portion data) are three-dimensionally displayed using polygon display, for example. The earth cutting plan data (earth cutting portion data) and the earth filling plan data (earth filling portion data) are displayed in different designs (colors or patterns) so that the both data can be distinguished from each other when being displayed in an overlapped manner as described later.

In addition, the construction plan data output unit 32 causes the display device 704 to display, in an overlapped manner, the design landform data, the earth cutting plan data (earth cutting portion data), and the earth filling plan data (earth filling portion data) in the construction range. The design landform data, the earth cutting plan data (earth cutting portion data), and the earth filling plan data (earth filling portion data) are displayed in an overlapped manner in different designs.

In addition, the construction plan data output unit 32 causes the display device 704 to display earth cutting numerical data and earth filling numerical data. In the example illustrated in FIG. 13, an earth cutting amount “21,660 m³” is displayed as the earth cutting numerical data, and an earth filling amount “19,198 m³” is displayed as the earth filling numerical data.

In addition, the construction plan data output unit 28 may cause the display device 704 to three-dimensionally display, side by side, the current landform data and the earth cutting plan data (earth cutting portion data or the earth cutting amount data), or to display, side by side, the current landform data and the earth filling plan data (earth filling portion data or the earth filling amount data). The construction plan data output unit 28 can cause the display device 704 to three-dimensionally display, side by side, at least two of current landform data, design landform data, construction range data, earth cutting plan data (earth cutting portion data or earth cutting amount data), and earth filling plan data (earth filling portion data or earth filling amount data).

In addition, the construction plan data output unit 28 may cause the display device 704 to display, in an overlapped manner, current landform data and earth cutting plan data (earth cutting portion data or earth cutting amount data), and to display, in an overlapped manner, current landform data and earth filling landform data (earth filling portion data or earth filling amount data) The construction plan data output unit 28 can cause the display device 704 to display, in an overlapped manner, at least two of current landform data, design landform data, construction range data, earth cutting plan data (earth cutting portion data or earth cutting amount data), and earth filling plan data (earth filling portion data or earth filling amount data).

In addition, the construction plan data output unit 28 may cause the display device 704 to display earth cutting numerical data, and not to display earth filling numerical data. In addition, the construction plan data output unit 28 may cause the display device 704 to display earth filling numerical data, and not to display earth cutting numerical data. As described above, by displaying earth cutting plan data, earth filling plan data, design landform data, current landform data, and the like on the display device 704 through three-dimensional display, a manager or the like of the construction site can recognize a location, a type, and a degree of necessary construction. In addition, for example, by displaying, in an overlapped manner, current landform data and earth cutting plan data or earth filling plan data, progress of construction can be recognized.

The original unit data acquisition unit 26 acquires original unit data indicating a specific condition of a work device (Step S70).

The original unit data acquisition unit 26 acquires original unit data (default value) of a work device with a standard specification, among a plurality of original unit data stored in the original unit data storage unit 41. The work device with the standard specification includes an excavator with a standard specification that includes a standard bucket, a bulldozer with a standard specification that includes a standard blade, and a standard transporter vehicle that includes a standard vessel.

The transport condition data acquisition unit 30 acquires transport condition data (Step S80). The transport condition data is input from the input unit 50. The input unit 50 is manipulated, and an input signal of the input unit 50 that corresponds to the manipulation is acquired by the transport condition data acquisition unit 30. In the present embodiment, the input unit 50 includes the input device 703 of the mobile terminal 7, and an input signal generated by the input device 703 being manipulated is transmitted to the transport condition data acquisition unit 30 via the Internet.

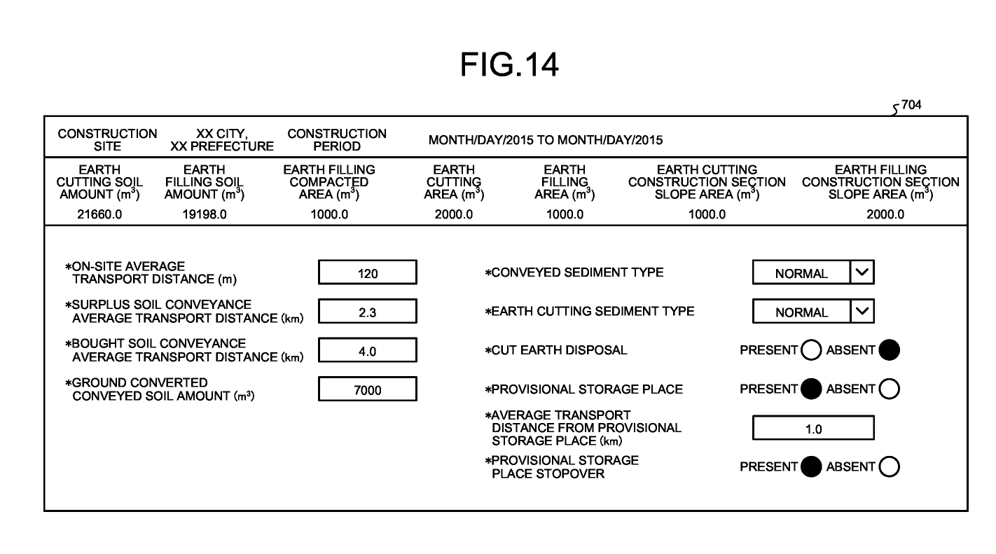

In the input performed by the input device 703, an input screen prompting an input of transport condition data is displayed on the display device 704. FIG. 14 illustrates a display example of the display device 704 that displays input fields for prompting an input of transport condition data. The worker Ma that can manipulate the mobile terminal 7 manipulates the input device 703 of the mobile terminal 7, and inputs transport condition data of the transporter vehicle 5 into the input fields displayed on the display device 704. As illustrated in FIG. 14, as transport condition data, input fields as to an on-site average transport distance, a surplus soil conveyance average transport distance, a bought soil conveyance average transport distance, a ground converted conveyed soil amount, a conveyed sediment type, an earth cutting sediment type, presence or absence of cut earth disposal, presence or absence of a provisional storage place, an average transport distance from the provisional storage place, and presence or absence of provisional storage place stopover are provided. A person who can manipulate the mobile terminal 7 may be the worker Mb of the construction company 12.

The on-site average transport distance indicates an average value, per unit time (for example, per day), of travel distances for which the transporter vehicle 5 travels in the construction site 3 in a state in which sediment is loaded. As an example, FIG. 14 illustrates an example in which “120” is input into the input field of the on-site average transport distance [m].

The surplus soil conveyance average transport distance indicates an average value of travel distances for which the transporter vehicle 5 travels when conveying surplus soil generated in the construction site 3, to a surplus soil storage place provided on the outside of the construction site 3. As an example, FIG. 14 illustrates an example in which “2.3” is input into the input field of the surplus soil conveyance average transport distance [km].

The bought soil conveyance average transport distance indicates an average value of travel distances for which the transporter vehicle 5 travels when conveying new sediment from a borrow pit provided on the outside of the construction site 3, to the construction site 3. As an example, FIG. 14 illustrates an example in which “4.0” is input into the input field of the bought soil conveyance average transport distance [km].

The ground converted conveyed soil amount indicates a value obtained by converting sediment conveyed from the borrow pit to the construction site 3, into a size (volume) of a ground of the construction site 3. As an example, FIG. 14 illustrates an example in which “7000” is input into the input field of ground converted conveyed soil amount [m³].

The conveyed sediment type indicates a type or a state of sediment conveyed by the transporter vehicle 5 from the outside of the construction site 3. The earth cutting sediment type indicates a type or a state of sediment excavated in the construction site 3, and conveyed by the transporter vehicle 5. In the present embodiment, the conveyed sediment type and the earth cutting sediment type are selected from “normal”, “argilliferous”, and “sandy”. As an example, FIG. 14 illustrates an example in which “normal” is input into the input field of the conveyed sediment type, and “normal” is input into the earth cutting sediment type.

The presence or absence of cut earth disposal includes selecting whether to dispose of sediment cut in the construction site 3. As an example, FIG. 14 illustrates an example in which “absent” is selected for the cut earth disposal.

The presence or absence of a provisional storage place includes selecting whether a place for provisionally storing sediment cut in the construction site 3 exists. As an example, FIG. 14 illustrates an example in which “present” is selected for the provisional storage place.

If a provisional storage place exists, the average transport distance from the provisional storage place indicates an average value of travel distances for which the transporter vehicle 5 travels when conveying sediment from the provisional storage place to the construction site 3. As an example, FIG. 14 illustrates an example in which “1.0” is input into the input field of the average transport distance [km] from the provisional storage place.

The presence or absence of provisional storage place stopover includes selecting whether the transporter vehicle 5 that conveys sediment into the construction site 3 passes though the provisional storage place. As an example, FIG. 14 illustrates an example in which “present” is selected for the provisional storage place stopover.

In addition, FIG. 14 illustrates an example in which earth cutting numerical data and earth filling numerical data are displayed on the display device 704 as construction amount data, together with the input fields. An earth cutting soil amount “21660.0 m³” is displayed as the earth cutting numerical data, and an earth filling soil amount “19198.0 m³” is displayed as the earth filling numerical data. In addition, a location of the construction site 3, and a scheduled construction period that is based on construction condition data are displayed on the display device 704.

In addition, an earth filling compacted area, an earth cutting area, an earth filling area, an earth cutting construction section slope area, and an earth filling construction section slope area are also displayed on the display device 704.

The construction pattern acquisition unit 28 acquires a construction pattern of a work device (Step S90). The construction pattern is input from the input unit 50 (input device 703). The input device 703 is manipulated, and an input signal generated according to the manipulation is acquired by the construction pattern acquisition unit 28 via the internet.

In the input performed by the input device 703, an input screen prompting an input of a construction pattern is displayed on the display device 704. An icon for prompting an input (selection) of a construction pattern is displayed on the display device 704. The worker Ma that can manipulate the mobile terminal 7 manipulates the input device 703 of the mobile terminal 7, and selects a specific icon from among a plurality of icons displayed on the display device 704. The plurality of icons is associated with a plurality of construction patterns stored in the construction pattern storage unit 43. By the icon being selected by the input device 703, the construction pattern acquisition unit 28 acquires, among the plurality of construction patterns stored in the construction pattern storage unit 43, the construction pattern selected according to the input signal of the input device 703 (the input unit 50).

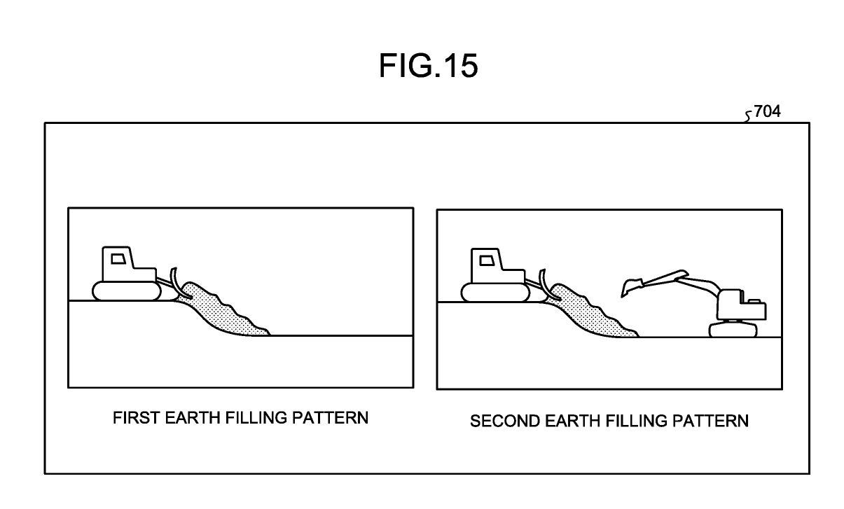

FIG. 15 illustrates a display example of the display device 704 that displays icons for prompting an input (selection) of a construction pattern. FIG. 15 is a diagram illustrating an example of icons corresponding to a first earth filling pattern and a second earth filling pattern of executing an earth filling work using a work device, among a plurality of construction patterns stored in the construction pattern storage unit 43.

The first earth filling pattern is an earth filling pattern in which an earth filling work is executed using sediment dozed by the bulldozer 4A.

The second earth filling pattern is an earth filling pattern in which an earth filling work is executed using sediment dozed by the bulldozer 4A, and the filled sediment is shaped by the excavator 4B.

In addition, each of the earth filling patterns illustrated in FIG. 15 is an example. The earth filling work may be executed only by the excavator 4B, the earth filling work may be executed by at least two bulldozers 4A, and the earth filling work may be executed by at least two excavators 4B. N types (N is a natural number equal to or larger than 3) of earth filling patterns are stored in the construction pattern storage unit 43. N types of icons corresponding to N types of earth filling patterns are displayed on the display device 704. The worker Ma selects a specific icon from among the N types of icons, and manipulates the input device 703. An earth filling pattern selected according to an input signal of the input device 703 is thereby acquired by the construction pattern acquisition unit 28.

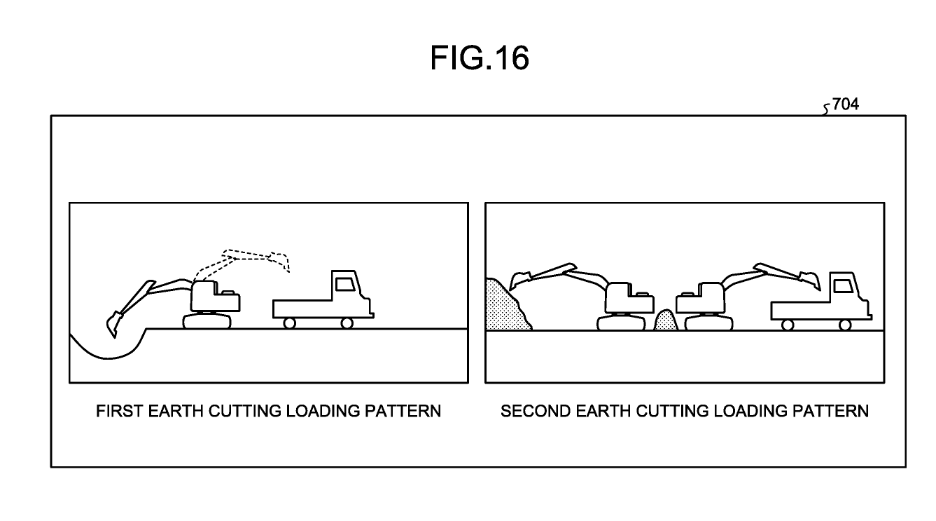

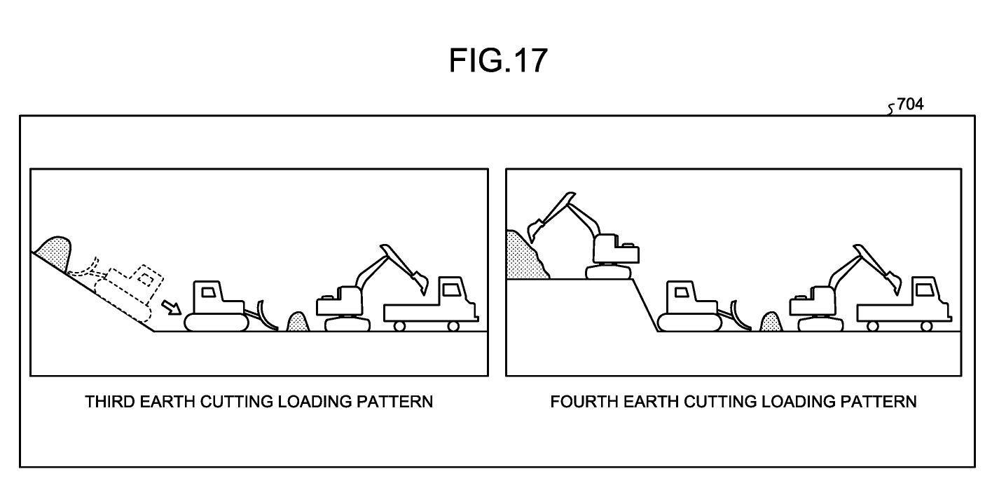

FIGS. 16 and 17 each illustrate a display example of the display device 704 that displays icons for prompting an input (selection) of a construction pattern. FIGS. 16 and 17 are diagrams illustrating examples of icons corresponding to a first earth cutting loading pattern, a second earth cutting loading pattern, a third earth cutting loading pattern, and a fourth earth cutting loading pattern of executing an earth cutting work and a loading work using a work device, among a plurality of construction patterns stored in the construction pattern storage unit 43.

The first earth cutting loading pattern is an earth cutting loading pattern in which a ground is cut by the excavator 4B, and the cut sediment is loaded onto the transporter vehicle 5 by the vehicle main body 400B swinging, without the travel apparatus 450B of the excavator 4B substantially moving.

The second earth cutting loading pattern is an earth cutting loading pattern in which a ground is cut by a first excavator 4B, a second excavator 4B and the transporter vehicle 5 come close to each other, and the sediment cut by the first excavator 4B is loaded onto the transporter vehicle 5 by the second excavator 4B.

The third earth cutting loading pattern is an earth cutting loading pattern in which a ground is cut by the bulldozer 4A, and sediment dozed by the bulldozer 4A is loaded onto the transporter vehicle 5 by the excavator 4B.

The fourth earth cutting loading pattern is an earth cutting loading pattern in which a ground is cut by the first excavator 4B, sediment cut by the first excavator 4B is dozed by the bulldozer 4A, and the sediment dozed by the bulldozer 4A is loaded onto the transporter vehicle 5 by the second excavator 4B.

In addition, each of the earth cutting loading patterns illustrated in FIGS. 16 and 17 is an example. N types (N is a natural number equal to or larger than 3) of earth cutting loading patterns are stored in the construction pattern storage unit 43. N types of icons corresponding to N types of earth cutting loading patterns are displayed on the display device 704. The worker Ma selects a specific icon from among the N types of icons, and manipulates the input device 703. An earth cutting loading pattern selected according to an input signal of the input device 703 is thereby acquired by the construction pattern acquisition unit 28.

In addition, construction patterns may include patterns of transport performed by the transporter vehicle 5, which are not illustrated in the drawings. The worker Ma can select a specific transport pattern from among a plurality of transport patterns, by manipulating the input device 703.

Based on the construction amount data calculated in Step S50, the original unit data acquired in Step S70, the transport condition data acquired in Step S80, and the construction pattern acquired in Step S90, the construction plan data calculation unit 20 calculates, for each of a plurality of target construction periods, a construction plan and a construction cost required when construction is executed using the construction plan (Step S100).

Based on the construction amount data, the original unit data, the transport condition data, and the construction pattern, the construction plan data calculation unit 20 simulates construction for each of the plurality of target construction periods, and formulates an optimum construction plan for each of the plurality of target construction periods.

As mentioned above, the original unit data includes work ability of a work device, and as an example, includes a size of the work member 440. Thus, for example, an amount of soil that can be excavated by the bucket 440B through one excavation operation is obtained based on the original unit data. The number of excavation operations of the bucket 440B necessary for shaping a current landform into a design landform is obtained based on a difference between current landform data and design landform data. In addition, the number of excavation operations of the excavator 4B that can be executed per unit time (work ability of the excavator 4B) is also obtained from original unit data being known data. Thus, which excavator 4B is to be used, and how many excavators 4B are required for completing construction within a target construction period can be calculated.

In addition, in the case of transporting sediment from the outside of the construction site 3 into the construction site 3 using the transporter vehicle 5 for performing earth filling, if the transporter vehicle 5 travels on a general road, a timing at which a transporter vehicle 3 transports sediment into the construction site 3, or an amount of sediment that can be transported per unit time may vary depending on a travel route, a travel speed, a traffic condition (presence or absence of traffic jam, etc.), and the like. For example, if the transporter vehicle 5 arrives at the construction site 3 after a target timing, there is a possibility of occurrence of a situation in which a work of the construction machine 4 or the worker Ma needs to be interrupted until the transporter vehicle 5 arrives at the construction site 3. Thus, based on transport condition data related to the transporter vehicle 5 (surplus soil conveyance average transport distance or bought soil conveyance average transport distance) that includes a travel route of the transporter vehicle 5, an expected time point of arrival at the construction site 3, and the like, a construction plan can be formulated so that an efficient work is executed.

In addition, even if a work device having identical work ability is used, a work speed varies depending on soil properties. For example, when the case of cutting, filling, or dozing argilliferous sediment, and the case of cutting, filling, or dozing sandy sediment are compared, even if a work device having identical work ability is used, a work speed declines and a work time elongates in the case of processing argilliferous sediment, as compared with those in the case of processing sandy sediment. A work speed of a work device that corresponds to a soil property can be obtained in advance. Thus, by considering transport condition data including a conveyed sediment type and an earth cutting sediment type, a work time required when a certain work device is used can be simulated.

Based on the construction pattern, the number of work devices used, and work content of the work devices are determined. Thus, if a specific work is executed in a specific construction pattern using a work device derived from original unit data, a time and a cost required until the end of the work can be estimated. Thus, based on construction amount data, original unit data, and a construction pattern, the construction plan data calculation unit 20 can highly-accurately calculate a time and a cost required until the completion of a specific work (earth cutting work or earth filling work) if a specific work device derived from original unit data is used in a specific construction pattern. In addition, based on the construction pattern, the construction plan data calculation unit 20 can obtain which work device is to be used and how many work devices are to be used, or which type of worker is to be input into a work site, and how many workers are to be input into the work site.

In addition, construction simulation may be executed considering variation factor data. A soil property may vary during the progress of excavation of the construction site 3. Even if a work device having identical work ability is used, a work speed varies depending on soil properties. For example, when the case of excavating an argilliferous land surface, and the case excavating a sandy land surface are compared, even if a work device having identical work ability is used, a work speed declines and a work time elongates in the case of excavating the argilliferous land surface, as compared with those in the case of excavating the sandy land surface. Soil properties are known data that can be obtained in advance through a preliminary survey such as a boring survey. In addition, a work speed of a work device that corresponds to a soil property can also be obtained in advance. Thus, by considering variation factor data including soil property data, a work time required when a certain work device is used can be simulated.

In addition, a difficulty of construction (trafficability) varies between rainy weather and fine weather. The ability of a land surface that can stand the traveling of a work device (travelable degree) is referred to as trafficability. For example, in rainy weather, a travelable maximum speed of the transporter vehicle 5 may become slower, and a work speed of the construction machine (e.g., the bulldozer 4A) may become slower, as compared with those in fine weather. A work speed of a work device and a travelable maximum speed of the transporter vehicle 5 that correspond to weather can also be obtained in advance. Thus, by considering variation factor data including weather data, a work time required when a certain work device is used can be simulated. In addition, based on the weather data, a construction plan of inputting the construction machine 4 having a rainproof or snowproof specification into the construction site 3 can be formulated. Examples of the construction machine 4 having a rainproof specification include the bulldozer 4A including a wide crawler so as to be able to travel on a muddy road surface, the transporter vehicle 5 including snowproof tires, or the like.

In addition, in some cases, a work available period in which construction can be executed, and a work unavailable period in which construction cannot be executed are determined by audit or work rules of the construction site 3. Schedule data indicating the work available time and the action unavailable time is known data identified in advance, and is stored in a construction condition database as construction condition data. If the construction condition data is acquired, the construction plan data calculation unit 20 may execute simulation of construction and calculate a construction plan, based on the construction condition data including the schedule data as mentioned above.

In addition, process design data indicating work content and a work procedure to be executed in construction is determined in advance, and stored in the construction condition database as construction condition data. The construction plan data calculation unit 20 may calculate construction plan data based on the construction condition data including the process design data.

The construction plan data output unit 32 causes the display device 704 to display relationship between the target construction periods and the construction costs that respectively correspond to the plurality of construction plans calculated in Step S100 (Step S110).

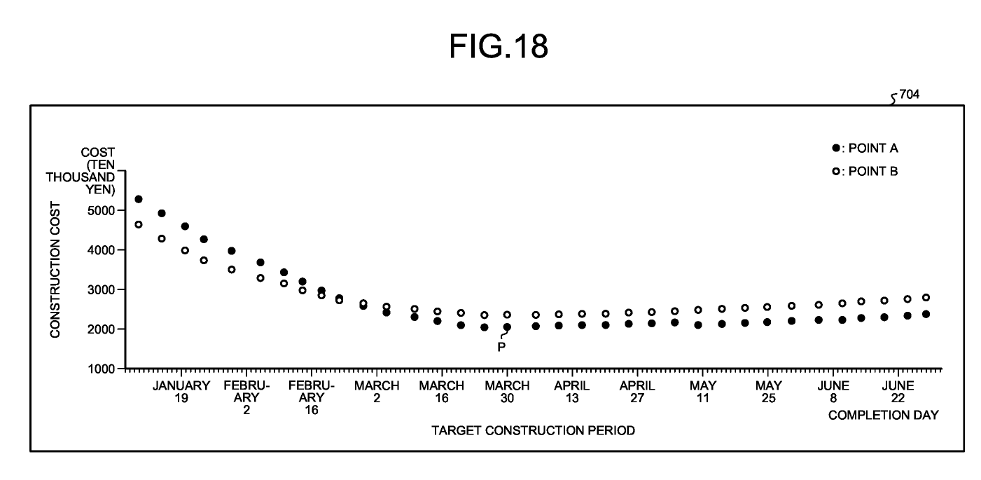

FIG. 18 is a diagram illustrating a display example of the display device 704 that displays relationship between a construction plan calculated for each of the plurality of target construction periods, and a construction cost required when construction is executed using the construction plan. As illustrated in FIG. 18, the construction plan data output unit 32 causes the display device 704 to display the plurality of target construction periods, and construction costs respectively corresponding to the plurality of target construction periods. The construction plan data output unit 32 causes the display device 704 to display relationship between the target construction periods and the construction costs that respectively correspond to the plurality of calculated construction plans.

As illustrated in FIG. 18, the construction plan data output unit 32 causes the display device 704 to output a graph in which a horizontal axis indicating a target construction period, and a vertical axis indicating a construction cost are defined. The construction plan data output unit 32 causes the display device 704 to display, in the graph, points indicating the construction plans respectively corresponding to the plurality of target construction periods.

In the example illustrated in FIG. 18, the horizontal axis indicates dates being target construction periods. In addition, the horizontal axis may indicate the numbers of days left to the target construction periods. The vertical axis indicates a construction cost (cost) required when construction is executed up to a target construction period according to a construction plan calculated by the construction plan data calculation unit 20.

In addition, in the present embodiment, construction simulation is executed for each of a case in which an ICT construction machine is used as the construction machine 4, and a case in which a normal construction machine not having an ICT function is used. In FIG. 18, points A indicated by black circles indicate construction simulation results obtainable when an ICT construction machine is used. Points B indicated by white circles indicate construction simulation results obtainable when a normal construction machine not having an ICT function is used. As illustrated in FIG. 18, it can be seen that, if a target construction period becomes longer, construction efficiency becomes higher and a construction cost is suppressed in the case of using the ICT construction machine, as compared with the case of using the normal construction machine. In addition, a graph indicating relationship between target construction periods and construction costs that respectively correspond to a plurality of construction plans may be indicated as a bar graph.

As illustrated in FIG. 18, display is performed by the display device 704 using points in which a plurality of target construction periods is associated with construction costs. Each point illustrated in FIG. 18 includes calculated construction plan data. If the worker Ma selects a specific point from among a plurality of points displayed on the display device 704, by manipulating the input device 703, a construction plan corresponding to the selected point is displayed on the display device 704 in a display form using, for example, popup display or balloon display.

For example, if it is desired that “March 30 is desired to be set as a target construction period using the ICT construction machine”, the worker Ma manipulates an operating device 703 while viewing a display screen of the display device 704 illustrated in FIG. 18, and selects, from among the plurality of points displayed on the display device 704, a point P having March 30 as a target construction period in a case where the ICT construction machine is used. If the input device 703 includes a mouse, the worker Ma puts a cursor of the mouse on the point P and clicks the point. If the input device 703 includes a touch panel, the worker Ma taps the point P displayed on the display screen. Among the plurality of target construction periods displayed on the display device 704, a specific target construction period (March 30) and a construction cost that correspond to the point P are thereby displayed according to an input signal of the input device 703. Here, if a certain point is selected, in addition to a target construction period and a construction cost, information related to a type and a vehicle rank of a necessary construction machine 4, and information related to a vehicle rank and the number of transporter vehicles 5 may be displayed.

The construction plan data output unit 32 causes the display device 704 to display a construction plan corresponding to a target construction period selected according to an input signal of the input device 703, among the plurality of target construction periods displayed on the display device 704. In other words, the construction plan data output unit 32 causes the display device 704 to display a construction plan corresponding to a point (e.g., point P) selected according to an input signal of the input device 703, among the plurality of points indicating the construction plans respectively corresponding to the plurality of target construction periods that are displayed on the display device 704 (Step S120).

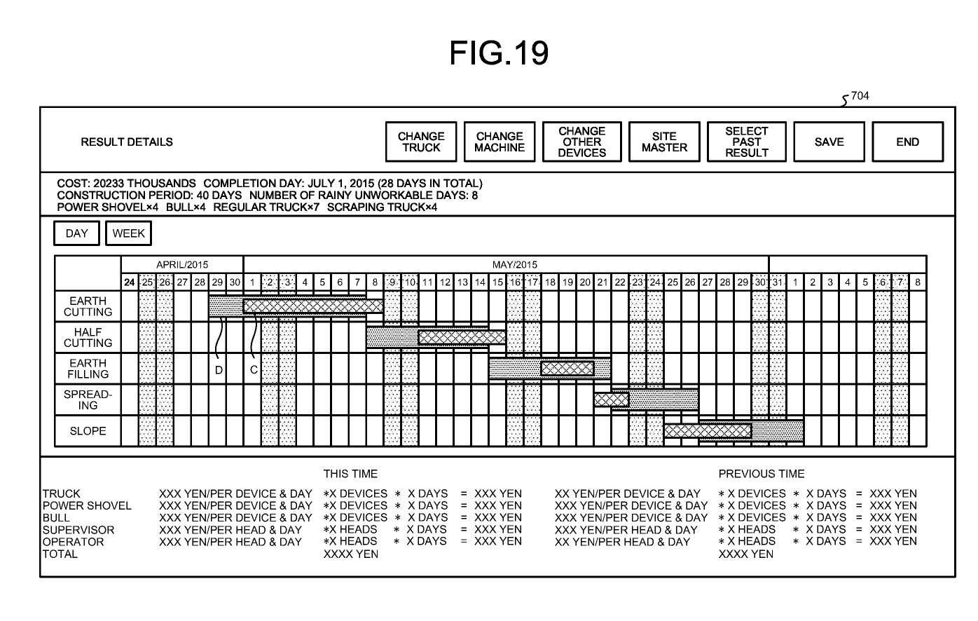

FIG. 19 illustrates a display example of the display device 704 that is obtained after clicking or tapping any point from the graph indicating the relationship between target construction periods and construction costs that respectively correspond to a plurality of construction plans. As illustrated in FIG. 19, as detailed data of the point, construction plan data including process sheet data and planned work device data of construction, and the like is displayed on the display device 704. As illustrated in FIG. 19, as construction plan data, process sheet data indicating a process sheet of construction that uses a work device is displayed. In addition, as construction plan data, planned work device data indicating a type, the number, and the like of work devices used in the construction site 3, and cost data indicating a cost required when construction is executed using the construction plan are displayed. On the display screen of the display device 704 that is illustrated in FIG. 19, a total amount displayed in the field of “total” displayed at the bottom corresponds to an amount of cost in FIG. 18.

As process sheet data, flow data indicating work content, a work procedure, and a work period of construction is displayed.

As flow data, items of a plurality of work contents are displayed. As an example, FIG. 19 illustrates an example in which “earth cutting” indicating an earth cutting work, “half cutting” indicating a half cutting excavation work, “earth filling” indicating an earth filling work, “spreading” indicating a spreading work, and “slope” indicating a slope excavation work are displayed.

In the example illustrated in FIG. 19, a work procedure is planned in the order of the earth cutting work, the half cutting excavation work, the earth filling work, the spreading work, and the slope excavation work.

Work period data of each work is displayed as a bar C and a bar D. The construction plan data output unit 32 causes the display device 704 to simultaneously display a construction plan calculated in the construction plan data calculation unit 20 at a first time point (for example, a current time point), and a construction plan calculated at a second time point (past time point) earlier than the first time point. In the example illustrated in FIG. 19, the bar C is a bar indicating a construction plan (process sheet) calculated at the first time point, and the bar D is a bar indicating a construction plan (process sheet) calculated at the second time point.

As an example, the earth cutting work calculated at the first time point is executed from May 1, 2015, and May 8 is set as a work construction period. The half cutting excavation work calculated at the first time point is executed from May 11, 2015, and May 15 is set as a work construction period. The earth filling work calculated at the first time point is executed from May 18, 2015, and May 20 is set as a work construction period. The spreading work calculated at the first time point is executed from May 21, 2015, and May 22 is set as a work construction period. The slope excavation work calculated at the first time point is executed from May 25, 2015, and May 29 is set as a work construction period.

On the other hand, the earth cutting work calculated at the second time point is executed from Apr. 29, 2015, and May 7 is set as a work construction period. The half cutting excavation work calculated at the second time point is executed from May 8, 2015, and May 14 is set as a work construction period. The earth filling work calculated at the second time point is executed from May 15, 2015, and May 21 is set as a work construction period. The spreading work calculated at the second time point is executed from May 22, 2015, and May 26 is set as a work construction period. The slope excavation work calculated at the second time point is executed from May 27, 2015, and June 1 is set as a work construction period. In this manner, comparison can be performed between a simulation result of a construction plan obtained in the past, and a simulation result of a construction plan currently obtained.

As planned work device data, resource data such as a “truck (dump truck)”, a “power shovel (excavator)”, a “bull (bulldozer)”, a “supervisor (site supervisor)”, and an “operator (worker)” is displayed. In addition, a cost per day of each of these resources, the number of devices (heads) used, operating days in construction, and a cost required when each resource is operated for all operating days are displayed. In addition, a numerical value such as a cost of a resource per day is an example.

Also for these cost data and the like, data calculated at the first time point (this time) and data calculated at the second time point (previous time) are simultaneously displayed on the display device 704.

As described with reference to FIGS. 18 and 19, the construction plan data calculation unit 20 calculates, for each of a plurality of target construction periods, construction plan data including a construction plan and a construction cost required when construction is executed using the construction plan. In the present embodiment, based on a plurality of construction plan data respectively calculated for a plurality of target construction periods, and client data, the construction plan data calculation unit 20 calculates necessary work device data for each of the plurality of target construction periods.

The construction plan data output unit 32 causes the display device 704 to display necessary work device data corresponding to a target construction period selected according to an input signal of the input device 703, among the plurality of target construction periods displayed on the display device 704. In other words, in the present embodiment, the construction plan data calculation unit 20 calculates necessary work device data based on construction plan data corresponding to a point (for example, point P) selected according to an input signal of the input device 703, among the plurality of points indicating the construction plans respectively corresponding to the plurality of target construction periods that are illustrated in FIG. 18, and client data. The construction plan data output unit 32 causes the display device 704 to display the calculated necessary work device data (Step S130).

The necessary work device data includes a work device that has been determined to be deficient in the execution of construction, and that the client needs to newly procure. In the present embodiment, the construction plan data calculation unit 20 calculates necessary work device data based on planned work device data and client data. The planned work device data in the construction plan data indicates a type of a work device necessary for completing construction of the construction site 3 within a target construction period and a target cost that correspond to a point (e.g., point P) selected according to an input signal of the input device 703, a vehicle rank of the work device, work ability of the work device, and the number of work devices. In addition, in the present embodiment, the planned work device data is calculated based on a construction pattern selected according to an input signal of the input device 703, from among the plurality of construction patterns of a work device that are stored in the construction pattern storage unit 43. If the client does not own or owns only a part of work devices (type, vehicle rank, work ability, and the number of work devices) indicated by the planned work device data calculated by the construction plan data calculation unit 20, for progressing construction according to the construction plan data, the client needs to newly procure a deficient work device not owned by itself.

In the present embodiment, if it is determined based on the planned work device data and the client data that the client does not own or owns only a part of work devices indicated by the planned work device data, data indicating a deficient work device not owned by the client may be displayed on the display device 704. The necessary work device data including a deficient work device may include, for example, an image (icon or animation) a indicating the work device and a numerical value indicating the number of deficient work devices. A display form of the necessary work device data is arbitrary.

After causing the display device 704 to display the construction plan data as illustrated in FIG. 19, the construction plan data output unit 32 causes the display device 704 to display necessary work device data corresponding to the construction plan data. The display device 704 may display necessary work device data including a deficient work device not owned by the client.

If it is determined that the client does not own or owns only a part of work devices indicated by planned work device data calculated by the construction plan data calculation unit 20, the construction plan data output unit 32 may cause the display device 704 to display provision data indicating procurement information related to a work device providable for compensating for the deficiency, based on necessary work device data including a work device determined to be deficient.

FIG. 19 illustrates an example in which necessary work device data corresponding to construction plan data is calculated based on planned work device data and client data, and work devices owned by the client can cover necessary work devices. As rental data, rental cost data indicating a cost required for rental of a work device may be calculated and displayed on the display device 704.

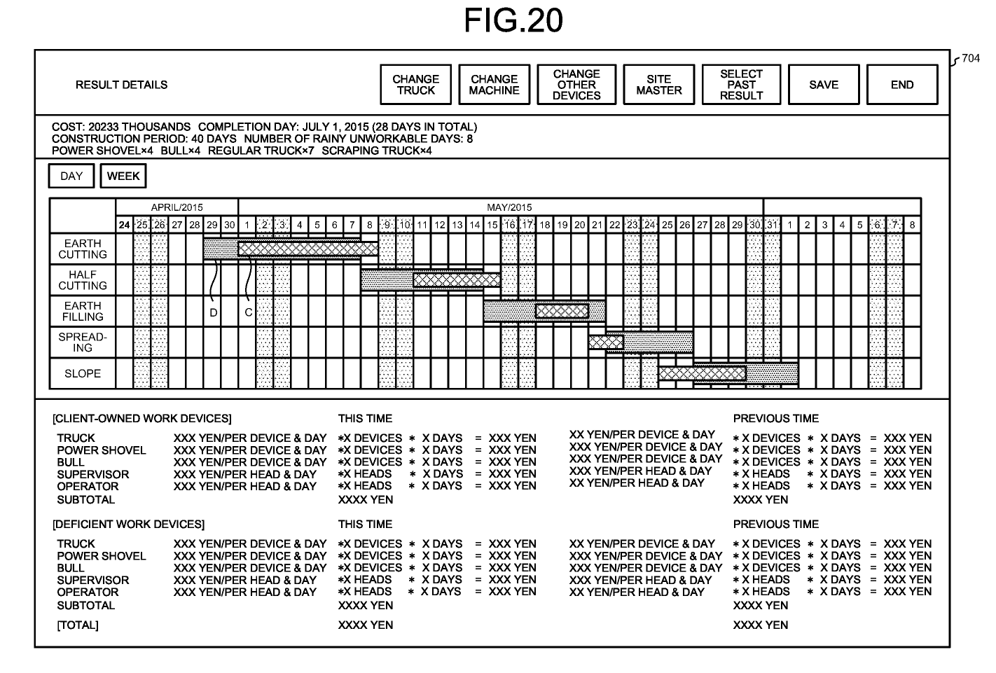

FIG. 20 illustrates an example of a display screen of the display device 704. The construction plan data calculation unit 20 calculates construction plan data indicating a construction plan of the construction site, according to the embodiment described with reference to FIG. 19. The construction plan data calculation unit 20 calculates planned work device data indicating work devices necessary for completing construction of the construction site 3 within the target construction period and the target cost, based on the construction plan data, according to the aforementioned embodiment.

The client data acquisition unit 31 acquires client data from the client data storage unit 45. As illustrated in FIG. 20, on the display screen of the display device 704, the construction plan data output unit 32 sets, as client data, a field of [client-owned work devices], and displays work device data owned by the client. The client data includes running costs of work devices owned by the client.

Based on the planned work device data and the client data, the construction plan data calculation unit 20 calculates deficient work device data indicating a work device deficient for completing construction of the construction site 3 within the target construction period and the target cost. In other words, the construction plan data calculation unit 20 calculates the number of deficient work devices by subtracting the number of client-owned work devices indicating the number of work devices owned by the client, from the number of necessary work devices indicating the number of work devices necessary for completing construction. On the display screen of the display device 704, the construction plan data output unit 32 sets, as deficient work device data, a field of [deficient work devices], and displays the deficient work device data.

If a deficient work device is supplemented using a rental service, the construction plan data calculation unit 20 calculates, as deficient work device data, rental cost data indicating a cost required for the rental of the work device. The rental cost data includes a rental charge required when the deficient work device is rented, and a running cost of the rented deficient work device.

The construction plan data calculation unit 20 calculates rental cost data based on rental work device data including a rental charge and a running cost of a work device to be rented. The rental work device data may be stored in the storage device 202 of the construction management system 1, or the construction management system 1 may acquire the rental work device data from a rental company via a communication line such as the internet.

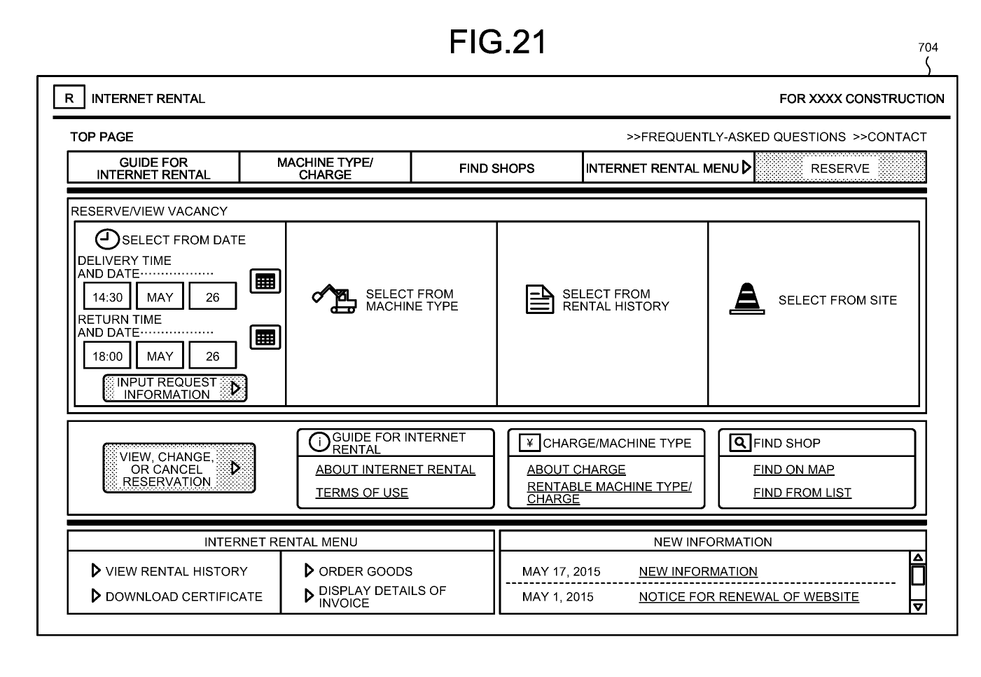

The construction plan data output unit 32 causes the display screen of the display device 704 to automatically transition from a display screen including construction plan data as illustrated in FIGS. 19 and 20, to a display screen including provision data indicating procurement information related to providable work devices as illustrated in FIG. 21.

FIG. 21 is a diagram illustrating an example in which rental data indicating rentable work devices is displayed on the display device 704 as provision data. As illustrated in FIG. 21, the construction plan data output unit 32 causes the display device 704 to display, as provision data, rental data indicating rentable work devices. In other words, in the present embodiment, if it is determined that the client does not own or owns only a part of work devices indicated by planned work device data calculated by the construction plan data calculation unit 20, a rental service screen for providing the client with a rental service of a work device is displayed on a display device 70.

The rental service screen illustrated in FIG. 21 includes a plurality of input forms and a graphical user interface (GUI) like a selection unit. By manipulating the input device 703, the worker Ma can input necessary items into the input forms displayed on the display device 704, and select a specific item from options displayed on the display device 704. For example, the worker Ma can input a desired rental period (the number of rental days) of a work device from the input form of “select from date”. In addition, by selecting (clicking or tapping) “select from machine type”, the worker Ma can designate a type of a work device desired to be rented. In addition, by selecting “select from rental history”, the worker Ma can designate a work device desired to be rented, from among work devices recorded as having been rented in the past. In addition, by selecting “select from site”, the worker Ma can designate a work device desired to be rented, from among work devices (stock in a storage facility) stored in a storage facility close to the construction site 3 among a plurality of storage facilities in which rental work devices are stored, for example.

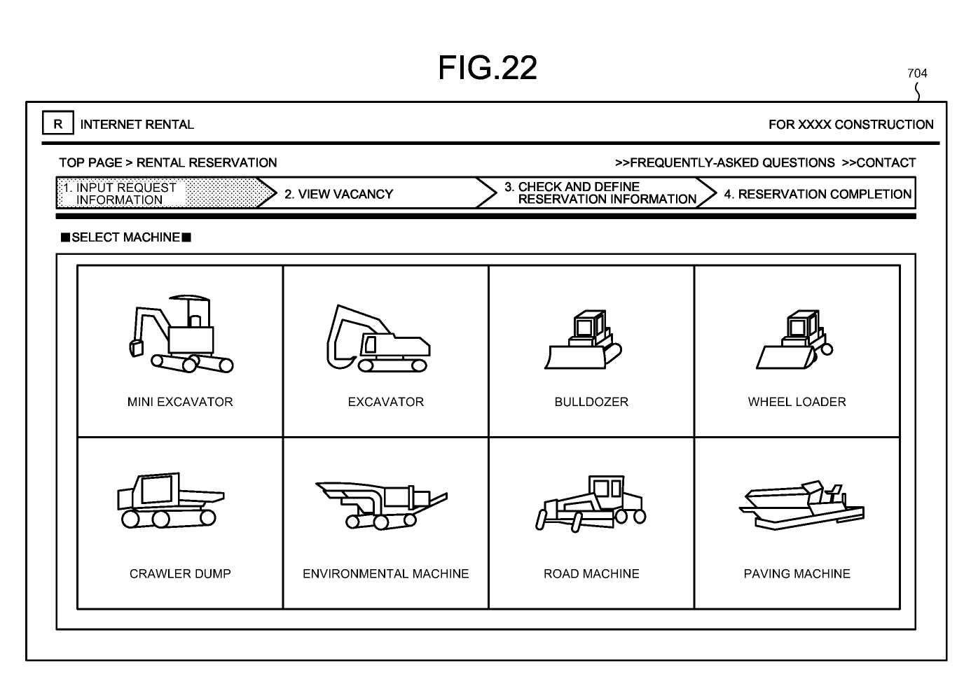

FIG. 22 illustrates a display example of the display device 704 that is to be displayed after “select from machine type” illustrated in FIG. 21 is selected. Information displayed in FIG. 22 also serves as rental data serving as provision data indicating procurement information related to providable work devices. By the selection of “select from machine type” illustrated in FIG. 21, the display device 704 automatically transitions from the display screen illustrated in FIG. 21, to the display screen illustrated in FIG. 22. As illustrated in FIG. 22, image data (icons or animation) indicating a list of rentable work devices is displayed on the display device 704. FIG. 22 illustrates an example in which, as rentable work devices, “mini excavator”, “excavator”, “bulldozer”, “wheel loader”, “crawler dump”, “environmental machine”, “road machine”, and “paving machine” are displayed on the display device 704. By manipulating the input device 703, the worker Ma can select or designate a work device desired to be rented, from among a plurality of work devices displayed on the display device 704. In addition, data related not only to a type of a work device, but also to a vehicle rank of the work device and work ability of the work device is also displayed on the display device 704, which is not illustrated in the drawing. In addition, an input form for inputting the number of work devices desired to be rented is also displayed. By manipulating the input device 703, the worker Ma can designate at least one of a type, a vehicle rank, work ability, and the number of work devices desired to be rented.

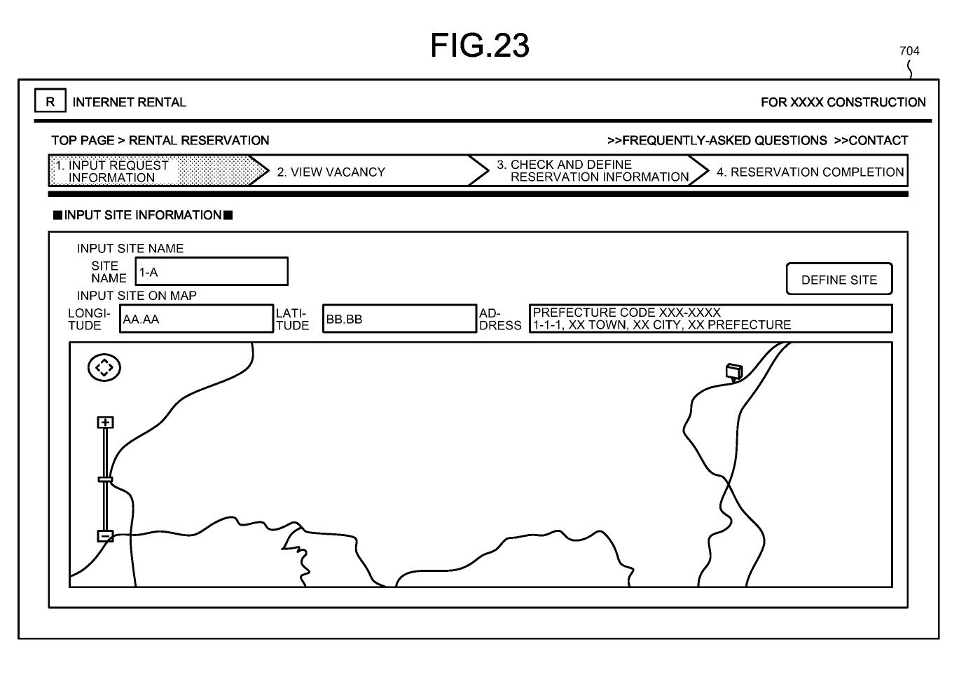

FIG. 23 illustrates a display example of the display device 704 that is to be displayed after “select from site” illustrated in FIG. 21 is selected. Information displayed in FIG. 23 also serves as rental data serving as provision data indicating procurement information related to providable work devices. By the selection of “select from site” illustrated in FIG. 21, the display screen of the display device 704 automatically transitions from the display screen illustrated in FIG. 21, to the display screen illustrated in FIG. 23. As illustrated in FIG. 23, map data is displayed on the display device 704. The map data displayed on the display device 704 may be air photograph or satellite photograph, or may be illustration. By clicking or tapping a part of the map on the display device 704, inputting a site name into an input form displayed on the display device 704, inputting latitude and longitude, or inputting address of a construction site, the worker Ma can designate a construction site in which a rented work device is desired to be used. In addition, by the manipulation of the input device 703, a position (absolute position) of a construction site in which a rented work device is desired to be used is identified. Here, stock of work devices in a storage facility close to the construction site may be displayed on the display device 704.

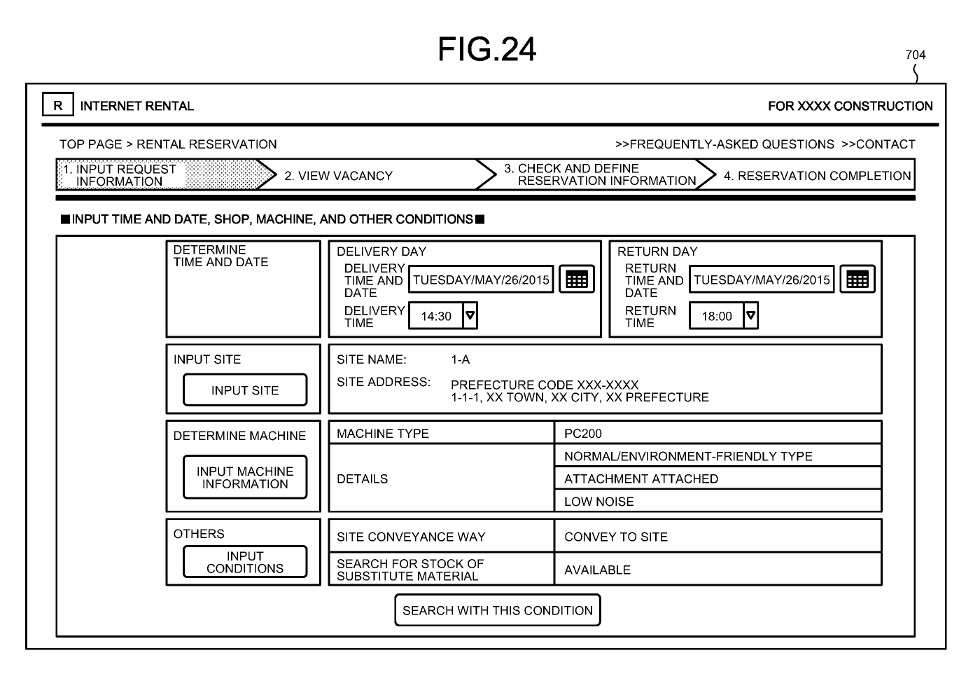

FIGS. 24, 25, and 26 are diagrams each illustrating an example of a rental service screen. FIG. 24 illustrates an example of a confirmation screen of input data input by the worker Ma. Information displayed in FIG. 24 also serves as rental data serving as provision data indicating procurement information related to providable work devices. After the input of input data related to a work device desired to be rented ends, the display screen transitions to the confirmation screen illustrated in FIG. 24. By viewing the display screen, the worker Ma can confirm a work device to be rented. By a “search with this condition” button being manipulated after the input data has been confirmed, rental work devices matching the condition of the input data are retrieved.

As described above, provision data indicating procurement information related to providable work devices includes all pieces of information to be supplied for procuring a work device. For example, information indicating a work device itself to be procured, information indicating a condition under which the work device is procured, information indicating processing, procedure, or other works necessary for procuring the work device, information indicating a procurement result, and the like are included. Specifically, provision data indicating procurement information related to providable work devices includes at least one of pieces of information about a type of a work device, a vehicle rank of the work device, work ability of the work device, the number of work devices, stock in a storage facility, the number of rental days of the work device required for construction, and a location of a construction site, which are necessary for construction. In addition, provision data may include a type of an attachment to be attached to the work device, which is required for construction.

In addition, based on necessary work device data including a work device determined to be deficient, the construction plan data output unit 32 may generate provision data indicating procurement information related to work devices providable for compensating for the deficient, and output the provision data from the output device 704 as recommendation data, and present the provision data to the client. In this case, the client (the worker Ma) can automatically receive provision data without viewing or manipulating the screens as illustrated in FIGS. 21, 22, 23, 24, and the like. It therefore becomes unnecessary to perform bothersome manipulations on a terminal. In this case, if provided recommendation data has no problem, only by the worker Ma manipulating the “search with this condition” button as illustrated in FIG. 24, on a terminal device, rental work devices indicated in the recommendation data are retrieved.

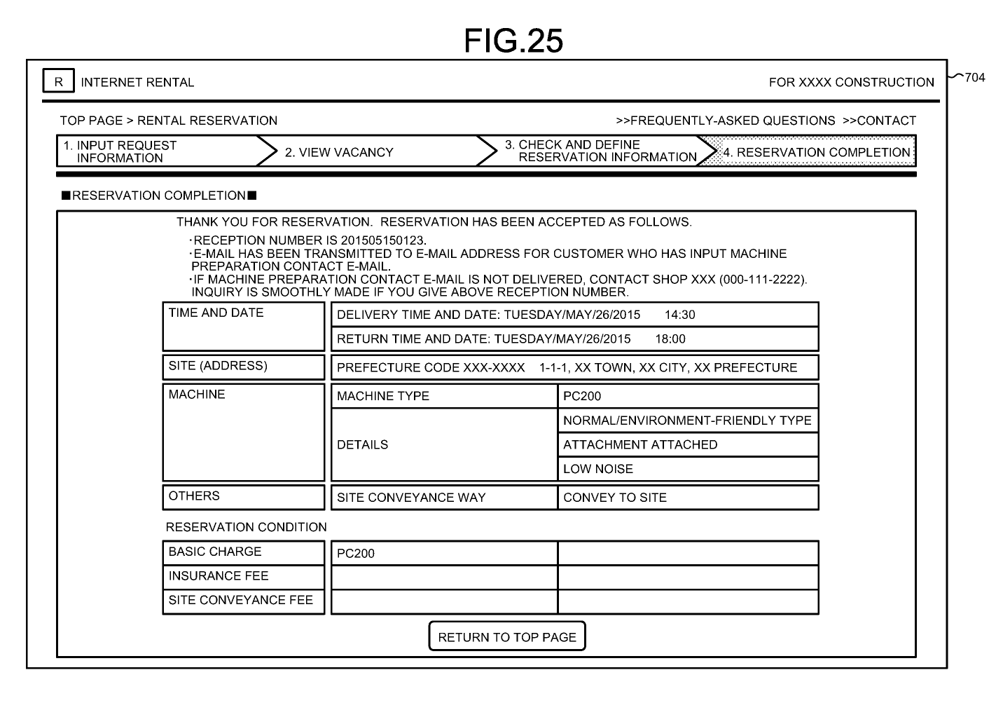

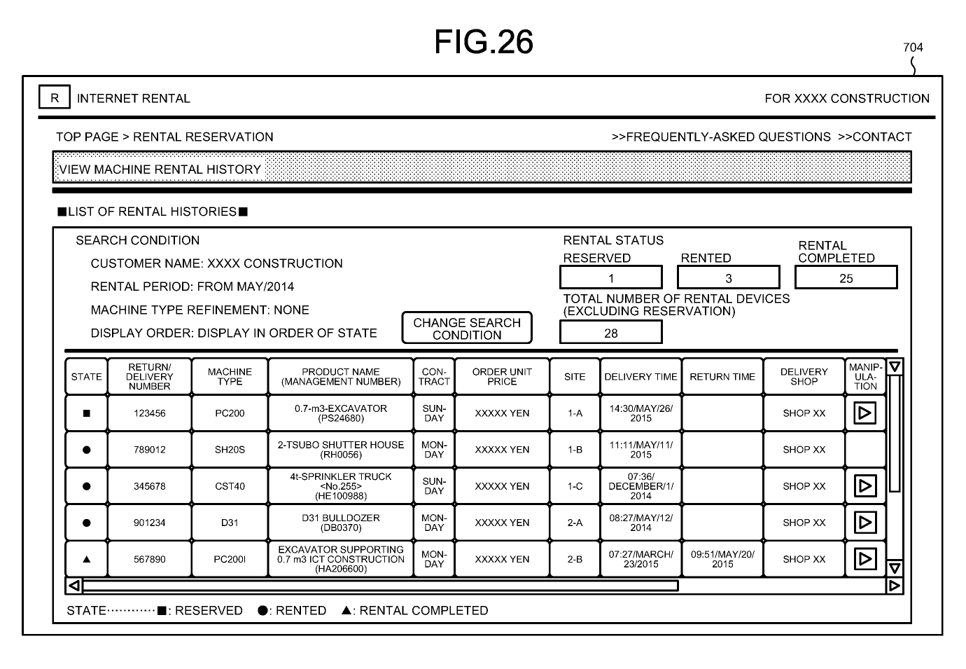

FIG. 25 illustrates an example of a confirmation screen displayed after rental reservation is defined. FIG. 26 illustrates an example a display screen that displays a list of rental histories.

As described above, if input data indicating information of a work device desired to be rented is input by the manipulation of the input device 703, the input data is transmitted to the computer system 2 via the internet. The computer system 2 accepts the input data (Step S140). Based on the input data, the construction plan data output unit 32 transmits, to a storage facility in which rental work devices are stored, command data for arranging the rental of a work device, via the internet (Step S150). The storage facility includes a service office or a shop in which rental work devices are stored. A work device desired by the worker Ma is thereby delivered to the construction site 3.

For example, if a construction site is designated by the manipulation of the input device 703, based on a position of the construction site that has been identified by the manipulation of the input device 703, the construction plan data output unit 32 designates a specific storage facility from among a plurality of storage facilities in which rental work devices are stored. Among a plurality of storage facilities existing across the whole country, for example, the construction plan data output unit 32 can transmit, to a storage facility closest to the designated construction site, or a storage facility having good traffic accessibility to the construction site, command data for arranging the rental of a work device.

In the construction site 3, construction is started based on the determined construction plan (Step S160). Design landform data and construction plan data are transmitted from the construction plan data output unit 32 to the construction machine 4. Based on the design landform data, the construction machine 4 performs construction of the construction site 3 while controlling the work member 440. This enables even the construction machine 4 manipulated by an inexperienced driver to perform highly-accurate construction in accordance with a design drawing. In addition, drastic enhancement in productivity is caused in the construction machine 4 manipulated by an experienced driver.

Construction result data is transmitted in real time, for example, to the computer system 2 from the construction machine 4 that performs works. The construction result data may be transmitted from the construction machine 4 to the computer system 2 at a fixed time of a day or periodically, for example. The construction result data acquisition unit 21 acquires the construction result data of the construction machine 4 (Step S170).

As described with reference to FIGS. 5 and 6, the construction machine 4 can detect an absolute position of the blade edge 440p that contacts a current landform. Based on an absolute position of a blade edge 400p, the construction machine 4 acquires position data indicating an absolute position in the Xg-axis direction, an absolute position in the Yg-axis direction, and an absolute position in the Zg-axis direction of each mesh point, and detects a current landform.

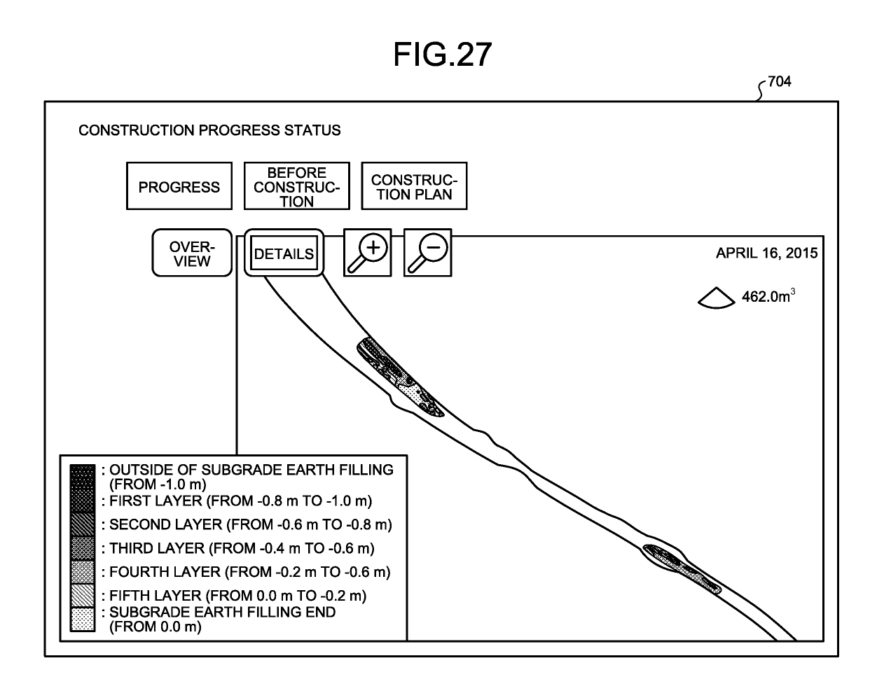

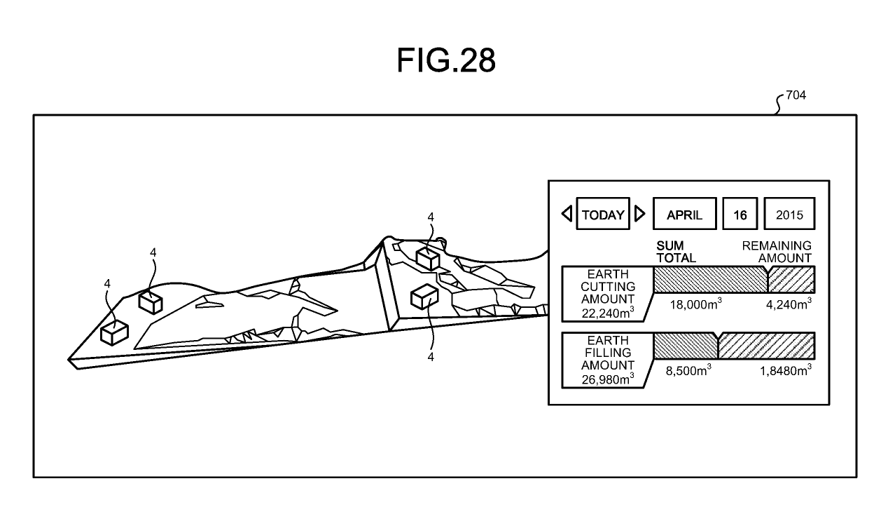

Position data of each mesh point is output to the construction result data acquisition unit 21. The display device 704 of the mobile terminal 7 displays the construction result data (Step S180). FIG. 27 illustrates a display example of construction result data, and a two-dimensionally displayed example. FIG. 28 illustrates a three-dimensionally displayed example. In this manner, workers can visually check, in real time, a construction result (performance) of the day. In other words, the construction management system 1 can always “visualize” a daily construction plan and construction result.

An example of construction result data illustrated in FIG. 27 will be described. A construction progress status at a certain time point (e.g., Apr. 16, 2015) in a certain construction site is two-dimensionally displayed. In the construction site, earth filling is performed. A situation in which earth filling has been performed on a subgrade a plurality of times (into a plurality of layers) is visualized by using different colors or different patterns. In addition, an accumulation amount of filled earth is displayed as a numerical value (e.g., 462.0 m³ in FIG. 27). In addition, if a button “before construction” is selected, colors and patterns in a state before construction are displayed, and if a button “construction plan” is selected, colors and patterns in a state of a construction plan are displayed. Through such two-dimensional display, the progress of construction can be visually recognized easily.

An example of construction result data illustrated in FIG. 28 will be described. A construction progress status at a certain time point (e.g., Apr. 16, 2015) in a certain construction site is three-dimensionally displayed. A current landform is three-dimensionally displayed using, for example, contrasting. The computer system 2 acquires, from each construction machine 4, absolute position data indicating an absolute position of an own vehicle that is obtained by the GPS receiver 4065 provided in the construction machine 4, and visually displays a position of the construction machine 4 in the construction site. In addition, as past work results, a targeted earth cutting amount (for example, 22,240 m³) and a targeted earth filling amount (for example, 26,980 m³) are displayed as numerical values, and each accumulation amount (sum total) and remaining amounts with respect to the targets are displayed using numerical values and bar graphs. Through such three-dimensional display, the progress of construction can be visually recognized easily.

By a construction plan and a construction result being “visualized”, so-called Plan Do Check Action (PDCA) that enables prompt execution of a series of works including construction planning before construction, management of construction progress during construction, and construction evaluation of construction can be rotated at high speed.

In addition, if there is a demand for a change of a design landform in the construction site 3, support is performed by the support center 14. In the support center 14, design landform data is modified, and the modified design landform data is reflected on process management.

In addition, design plan data and construction result data are accumulated in the result storage unit 46. In addition, current landform data, design landform data, mode data, original unit data, construction condition data, construction patterns, variation factor data, and transport condition data may be accumulated in the result storage unit 46. Taking advantage of these data accumulated in the result storage unit 46, the data can be utilized even after construction completion for maintenance/repair, future maintenance, a recovery work of areas suffering from a natural disaster, and the like, and can help a drastic reduction in work hours.

[Effects]

As described above, according to the present embodiment, based on construction plan data, necessary work device data indicating work devices necessary for executing construction of a construction site according to a calculated construction plan is calculated and displayed on the display device 704. With this configuration, the client can smoothly and promptly procure, before construction, work devices necessary for completing construction within a target construction period and a target cost. Thus, a decline of productivity in the construction site 3 is suppressed.

In addition, in the present embodiment, client data indicating work devices owned by the client is acquired in advance, and necessary work device data is calculated based on the construction plan data and the client data. The necessary work device data corresponding to work devices already owned by the client is thereby calculated. If the client does not own a part or all of necessary work devices, the unowned work devices are calculated as necessary work device data. Thus, according to work devices owned by itself, the client can identify which work devices are to be procured, and how many work devices are to be procured.

In addition, in the present embodiment, necessary work device data includes data indicating a work device determined to be deficient in construction executed according to a construction plan, and determined to be in need of being newly procured by the client. If the client does not own or owns only a part of work devices indicated by planned work device data calculated by the construction plan data calculation unit 20, data indicating a deficient work device is displayed on the display device 704 as necessary work device data. The client can thereby identify which work device and how many work devices are deficient for executing construction according to the construction plan. The client can thereby smoothly and promptly procure the deficient work device. If the client owns only a part of work devices indicated by planned work device data, a work device is newly procured and a deficient work device is compensated for, and construction can be executed using owned work devices and the newly-procured work device, according to the construction plan calculated by the construction plan data calculation unit 20. In addition, if the client does not own at all the work devices indicated by the planned work device data, all of the work devices indicated by the planned work device data are newly procured, and construction can be executed using the procured work devices, according to the construction plan calculated by the construction plan data calculation unit 20.

In addition, in the present embodiment, based on the necessary work device data, the construction plan data output unit 32 causes the display device 704 to display provision data indicating procurement information related to work devices providable for compensating for a deficient work device. In the present embodiment, the provision data includes rental data indicating rentable work devices, and the construction plan data output unit 32 causes the display device 704 to display the rental data. In other words, if it is determined based on necessary work device data that a work device is deficient for executing construction according to a construction plan, and the client needs to newly procure a work device, the construction management system 1 provides the client with a rental service of a work device as a way of the procurement. If it is determined by the construction management system 1 that a work device is deficient, the construction management system 1 provides the client with provision data (rental data) as a way of procurement of a new work device for compensating for a deficient work device. By the rental service screen being provided, the client can smoothly and promptly compensate for a deficient work device by manipulating a rental service screen, without feeling bother.

In addition, in the present embodiment, if it is determined that a work device is deficient, the construction plan data output unit 32 causes the display device 704 to display a display screen indicating construction plan data including planned work device data as illustrated in FIG. 19, and then, causes the display device 704 to display the rental service screen as illustrated in FIG. 21. By the rental service screen being automatically displayed after the construction plan data is displayed, the client is automatically provided with a rental service without feeling bother.

In addition, according to the present embodiment, based on the position of the construction site 3, the construction plan data output unit 32 designates a specific storage facility from among a plurality of storage facilities in which work devices are stored. By procuring, to the construction site 3, a work device stored in a storage facility closest to the construction site 3, or a storage facility having good traffic accessibility to the construction site 3, a procurement work can be smoothly executed in a short time.

In addition, according to the present embodiment, based on construction amount data and original unit data, a construction plan and a construction cost required when construction is executed using the construction plan are calculated for each of a plurality of target construction periods, and the target construction periods and the construction costs that respectively correspond to the plurality of calculated construction plans are displayed on the display device 704. For each of the plurality of calculated construction plans, a target construction period and a construction cost are visualized in a compared state. A worker or a manager can therefore sensuously recognize a construction plan promptly. Thus, enhancement in productivity in a construction site can be achieved.

In addition, according to the present embodiment, detailed data of a construction plan corresponding to a target construction period selected according to an input signal of the input unit 50, among a plurality of target construction periods output to the display device 704 is displayed on the display device 704. A worker or a manager can thereby overview relationship between a target construction period and a construction cost for each of the plurality of calculated construction plans, and then, recognize the details of the selected construction plan.

In addition, according to the present embodiment, because relationship between a target construction period and a construction cost of each of a plurality of calculated construction plans is displayed on the display device 704 as a graph, a worker or a manager can sensuously overview relationship between each of the plurality of construction plans, and a target construction period and a construction cost, promptly. In addition, in the graph, construction plans respectively corresponding to the plurality of target construction periods are displayed using points. Thus, a worker or a manager can cause the display device 704 to display detailed data of a construction plan only by selecting a point, and recognize the detailed data.

In addition, according to the present embodiment, based on a plurality of construction plan data respectively calculated for a plurality of target construction periods, and client data, the construction plan data calculation unit 20 calculates necessary work device data for each of the plurality of target construction periods. With this configuration, if a worker Wa selects any target construction period, the construction management system 1 can provide necessary work device data.

In addition, according to the present embodiment, a construction plan is calculated based on a construction pattern of a work device. In the simulation of construction, by a construction pattern being input as a simulation parameter, simulation accuracy is enhanced, and construction plan data can be accurately calculated.

In addition, according to the present embodiment, a plurality of construction patterns is patterned in advance, and is registered in the construction pattern storage unit 43. Thus, only by manipulating the input unit 50 (the input device 703), a worker or a manager can select an arbitrary construction pattern from among the plurality of construction patterns registered in the construction pattern storage unit 43, and use the construction pattern in construction simulation.

In addition, according to the present embodiment, necessary work device data is calculated based on construction plan data calculated based on a construction pattern, and client data. Thus, work devices required for construction can be smoothly and promptly procured according to a selected construction pattern.

In addition, according to the present embodiment, a construction plan is calculated based on transport condition data of the transporter vehicle 5. Thus, simulation accuracy of construction is further enhanced.

In addition, in the present embodiment, the construction plan data calculation unit 20 calculates process sheet data as construction plan data. Thus, a worker or a manager can visually recognize a process sheet displayed on the display device 704, promptly.

In addition, in the present embodiment, a construction plan calculated at the first time point (current time point, this time) and a construction plan calculated at the second time point (past time point, previous time) are simultaneously displayed on the display device 704. Thus, a worker or a manager can perform evaluation while comparing a construction simulation result performed in the previous time, and a construction simulation result performed in this time.

According to the present embodiment, because the construction management system 1 includes the current landform data acquisition unit 22, the design landform data acquisition unit 23, the original unit data acquisition unit 26, and the construction plan data calculation unit 20, the construction plan data calculation unit 20 can derive a construction range and a construction amount to be used in construction, based on current landform data and design landform data. Based on the derived construction range and construction amount, and original unit data, the construction management system 1 can formulate an optimum construction plan using the construction plan data calculation unit 20 of the computer system 2. Productivity in the construction site can be thereby enhanced, and labor shortage problems faced by the construction industry can be solved.

In the present embodiment, (1) an accurate construction plan can be created before construction and during construction, (2) a difference between a plan and a result (completed portion and completed volume) can be recognized in real time, (3) an optimum construction procedure and arrangement can be proposed, and (4) a construction plan can be calculated while predicting occurrence possibility of a variation factor. This can drastically enhance productivity in the construction site 3.

In addition, according to the present embodiment, the construction management system 1 can globally support the construction company 12 and works related to the construction of the construction site 3, throughout all the time including the time before construction, the time during construction, the time after construction, and the time of maintenance management.

In addition, according to the present embodiment, the camera 11 functioning as a detection device detects a current landform in a contactless manner, and wirelessly transmits current landform data to the current landform data acquisition unit 22 of the computer system 2. Measurement of the current landform and transmission of a measurement result can be thereby promptly performed.

In addition, according to the present embodiment, the camera 11 is mounted on the drone 10 being an unmanned air vehicle, and measures a current landform by aerially taking an image. This enables measurement to be ended in a short time.

In addition, according to the present embodiment, a specific condition of a work device that is indicated by original unit data includes at least one of a type and a vehicle rank of the work device, the number of work devices, and a management state of the work device. With this configuration, based on the original unit data, simulation accuracy of construction is enhanced, and an optimum construction plan can be formulated.

In addition, according to the present embodiment, a specific condition of a work device that is indicated by original unit data includes a work amount of the work device that can be executed per unit time. Construction simulation can be thereby highly-accurately performed for each unit time or for each process.

In addition, according to the present embodiment, the work device includes a work member that can change a current landform, and a work amount includes a size of the work member. Because the size of the work member is invariable data that can be known in advance, calculation burden of the work amount is reduced.

In addition, according to the present embodiment, the work device includes a transporter vehicle that transports sediment to a construction site, and the work amount includes an amount of sediment that can be transported per unit time. An amount of sediment that can be transported per unit time varies depending on travel conditions (travel route, travel distance, and travel speed) of the transporter vehicle 5 traveling on a general road, a traffic condition, a size of a vessel, and the like. By considering travel conditions of the transporter vehicle 5, a traffic condition, a size of a vessel, and the like, simulation accuracy of construction is enhanced, and optimum construction plan data is calculated. For example, if earth filling of sediment is required in the construction site 3, if it takes a long time for the transporter vehicle 5 on which sediment is loaded, to arrive at the construction site 3 due to a traffic condition, construction may stop. For preventing such a situation, construction plan data is calculated based on transport condition data of the transporter vehicle 5. This enhances productivity in the construction site 3.

In addition, according to the present embodiment, original unit data further includes a condition of a worker of a construction site. Productivity in the construction site 3 depends not only on a work device but also on a worker. Thus, by calculating a construction plan considering a condition of a worker as well, productivity in the construction site 3 is enhanced.

In addition, according to the present embodiment, a condition of a worker includes at least either one of the number of workers, and skill of the workers. With this configuration, simulation accuracy of construction is enhanced, and an optimum construction plan is formulated.

In addition, according to the present embodiment, the construction plan data calculation unit 20 cross-checks current landform data and design landform data, calculates construction range data indicating a construction range of a construction site, and soil amount data indicating an earth cutting amount or an earth filling amount of sediment required in the construction range, and calculates construction plan data based on the construction range data, the soil amount data, and the original unit data. Optimum construction plan data can be thereby calculated, and productivity in the construction site 3 can be enhanced.

In addition, according to the present embodiment, construction plan data includes at least one of planned work device data indicating a type, a vehicle rank, and the number of work devices used in the construction site, process sheet data indicating a process sheet of construction that uses the work device, and cost data indicating a cost required for construction. By the planned work device data, the process sheet data, and the cost data being calculated, actual construction is smoothly performed, and productivity is enhanced.

In addition, according to the present embodiment, the process sheet data includes at least one of flow data indicating a work procedure of construction, and work time data indicating a work time of each work of construction. The worker Ma can thereby smoothly execute works according to these data.

In addition, according to the present embodiment, the construction condition data acquisition unit 27 that acquires construction condition data indicating a construction condition in a construction site is included, and the construction plan data calculation unit 20 calculates construction plan data based on the construction condition data. By determining a construction condition being an initial condition or a constraint condition, solution can be promptly and appropriately obtained in construction simulation, and appropriate construction plan data can be calculated.

In addition, according to the present embodiment, the construction condition data includes at least one of a budget related to construction, a construction period, work content, a work procedure, a work time, and a site environment. By construction simulation being performed in a state in which a budget and a construction period are defined, a plurality of construction plans can be appropriately proposed within the ranges of the budget and the construction period. In addition, by work content, a work procedure, and a work time being predefined, appropriate construction plan data can be calculated under an appropriate work environment, and a targeted construction result can be obtained.

In addition, according to the present embodiment, a site environment includes at least either one of a landform of a construction site, and a size of the construction site. A time required for a work varies depending on a landform and a size of a construction site. Thus, by a landform and a size of the construction site being set, simulation accuracy of construction is enhanced.

In addition, according to the present embodiment, the variation factor data acquisition unit 29 that acquires variation factor data indicating a variation factor of a construction site is included, and the construction plan data calculation unit 20 calculates construction plan data based on the variation factor data. The variation factor data includes at least one of soil property data indicating a type and a state of sediment in the construction site, buried object data indicating a buried object buried under the construction site 3, and weather data of the construction site 3. A time required for a work varies depending on a soil property of the construction site. For example, between the case of heavy soil, the case of light soil, the case of argilliferous soil, and the case of sandy soil, times required for various works performed by the construction machine 4 that include an excavation work, an earth dozing work, an earth filling work, an earth cutting work, a land preparation work, a loading work, and the like vary. In addition, the easiness of travel (trafficability) of the transporter vehicle 5 varies depending on a soil property, and a time required for transport performed by the transporter vehicle 5 also varies. In addition, between the case of fine weather and the case of rainy weather, times required for works performed by a work device vary. By considering these variation factors attributed to natural phenomenon, simulation accuracy of construction is further enhanced, and appropriate construction plan data can be calculated.

In addition, according to the present embodiment, the support center 14 that accepts a change of a design landform is provided, the design landform data acquisition unit 23 acquires changed design landform data output from the support center 14, and the construction plan data calculation unit 20 recalculates construction plan data based on the changed design landform data. While reducing burden in the construction site 3 using the support center 14, the determination in the construction site 3 is accurately reflected on construction.

In addition, as described in the present embodiment, the remote control unit 33 that outputs a control signal for remotely manipulating a work device, based on the changed design landform data may be provided. With this configuration, burden on a driver of the work device is reduced, and informatization construction can be performed according to the changed design landform data.

In addition, according to the present embodiment, the construction result data acquisition unit 21 that acquires construction result data indicating a construction result of the construction site 3 is included, and the construction plan data calculation unit 20 recalculates construction plan data based on the construction result data. With this configuration, an optimum construction plan can be formulated in each case according to a progress status of construction.

In addition, according to the present embodiment, construction result data is displayed on the mobile terminal 7 functioning as an output device. A worker can thereby recognize a daily progress status of construction.

In addition, according to the present embodiment, a work device acquires construction result data, and the construction result data acquisition unit 21 wirelessly acquires construction result data 21 from the work device. With this configuration, a construction result can be promptly recognized in real time.

In addition, according to the present embodiment, the mode data acquisition unit 25 that acquires mode data indicating a prioritized item of construction is included, and the construction plan data calculation unit 20 calculates construction plan data based on the mode data. With this configuration, if a plurality of patterns of construction plans are proposed in the construction plan data calculation unit 20, a worker or a manager can acquire a construction plan compliant with a prioritized item, only by manipulating an input device, and transmitting the mode data to the mode data acquisition unit 25.

In addition, according to the present embodiment, the mode data includes at least either one of construction period prioritizing mode data that prioritizes a period of construction, and cost prioritizing mode data that prioritizes a cost of construction. By a construction period and a cost being set as prioritized items, a construction plan suitable for a budget and a target construction period can be selected.

In addition, in the present embodiment, if the client does not own work devices, or if it is determined that construction is not completed within a target construction period and a target cost, only with work devices owned by the client, as provision data for compensating for a deficient work device machine, rental data prompting the client to rent a work device is displayed on the display device 704. As provision data, purchase data prompting the client to purchase a new work device may be displayed on the display device 704. In other words, if it is determined that the client does not own or owns only a part of work devices necessary for performing construction, procuring a deficient work device includes the case of rental (lending) and the case of purchase.

In addition, in the aforementioned embodiment, client data is assumed to be data indicating work devices owned by the client. The client data may be data indicating work devices not owned by the client. In addition, if the client does not own any work device, the client data may be data indicating that the client owns no work device.

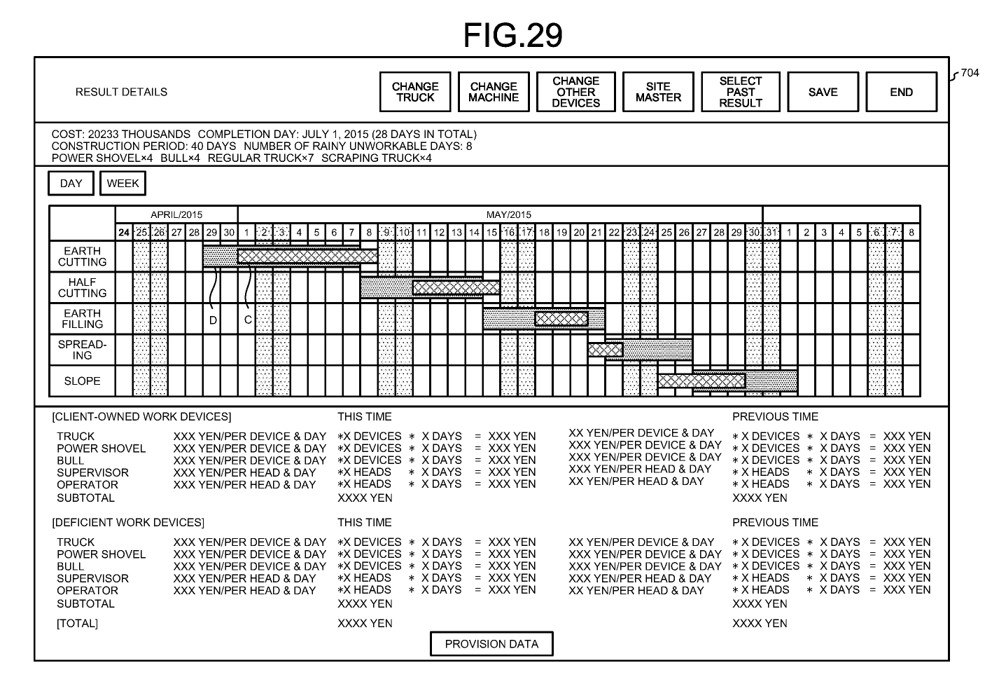

In addition, in the aforementioned embodiment, if it is determined that the client does not own or owns only a part of work devices indicated by planned work device data calculated by the construction plan data calculation unit 20, the construction plan data output unit 32 causes the display screen of the display device 704 to automatically transition from the display screen including construction plan data as illustrated in FIGS. 19 and 20, for example, to the display screen including provision data indicating procurement information related to providable work devices as illustrated in FIG. 21, for example. If it is determined that the client does not own or owns only a part of work devices indicated by planned work device data calculated by the construction plan data calculation unit 20, the construction plan data output unit 32 may cause the display screen of the display device 704 to transition to a display screen including construction plan data and a link button as illustrated in FIG. 29, for example. FIG. 29 illustrates, as an example, an example in which a link button in which characters “provision data” are described is displayed on the display device 704. By the client manipulating (clicking or tapping) the link button, the display screen illustrated in FIG. 29 transitions to a display screen including provision data as illustrated in FIG. 21. In addition, if it is determined that the client does not own or owns only a part of work devices indicated by planned work device data calculated by the construction plan data calculation unit 20, the construction plan data output unit 32 may cause the display screen of the display device 704 to automatically transition from the display screen including construction plan data as illustrated in FIG. 19, for example, to the display screen in which the link button is displayed. By the client manipulating the link button displayed on the display screen, the display screen on which the link button is displayed transitions to the display screen including provision data as illustrated in FIG. 21. In addition, the link button illustrated in FIG. 29 is an example. A phone number of a rental company may be displayed in the link button, or a uniform resource locator (URL) for jumping to a rental service screen of a rental company as illustrated in FIG. 21 or the like may be displayed therein. Such a link button, information of the phone number, and the information of the URL are also included in provision data. In addition, the link button and the URL serve as procurement guidance information for transitioning to a display screen including provision data as illustrated in FIG. 21.

In addition, in the aforementioned embodiment, if it is determined that the client does not own or owns only a part of work devices indicated by planned work device data calculated by the construction plan data calculation unit 20, a display screen including provision data as illustrated in FIG. 21 is displayed, or a display screen including the link button is displayed. If it is determined that the client owns all the work devices indicated by planned work device data calculated by the construction plan data calculation unit 20, that is, if it is determined that no work device is deficient in the execution of construction, the display screen including provision data as illustrated in FIG. 21 and the display screen including the link button need not be displayed.

In addition, in the aforementioned embodiment, the construction plan data calculation unit 20 simulates necessary work device data based on construction plan data and client data. Even without the client data, the construction plan data calculation unit 20 can calculate work devices necessary for the construction site (planned work device data). In this case, necessary work device data and planned work device data become equivalent. The construction plan data output unit 32 can cause the display device 704 to display a provision service screen (rental service screen or purchase service screen) for procuring work devices calculated to be necessary for the construction site.

In other words, in the present embodiment, the construction plan data calculation unit 20 that calculates, based on construction plan data indicating a construction plan of a construction site that has been calculated based on a current landform and a design landform of the construction site, and original unit data indicating a specific condition of a work device, necessary work device data indicating work devices necessary for executing construction of the construction site using the construction plan, and the construction plan data output unit 32 that causes the display device 704 (output device) to output the necessary work device data are provided. With this configuration, the object of suppressing a decline of productivity in the construction site can be achieved.

In addition, in the aforementioned embodiment, original unit data is assumed to be a default value among a plurality of original unit data stored in the original unit data storage unit 41. A construction plan may be calculated based on original unit data input via an input device (e.g., input device 703). In addition, original unit data stored in the original unit data storage unit 41 may be changed or updated based on original unit data input via the input device.

In addition, in the aforementioned embodiment, current landform data is assumed to be acquired using, as a flight vehicle, the drone 10 including a power source. As a flight vehicle, a model plane may be used, or a balloon not including a power source may be used. A current landform may be detected using a camera mounted on the balloon.

[Modified Example of Acquisition of Current Landform Data]

As described with reference to FIGS. 2 to 6, the construction machine 4 includes the vehicle main body 400, and the work member 440 that relatively moves with respect to the vehicle main body 400. The work member 440 includes the blade edge 400p that contacts a current landform. The construction machine 4 includes the processor 401 (the blade control device 401A, the bucket control device 401B) that detects a current landform based on an absolute position of the blade edge 440p. The absolute position of the vehicle main body 400 is detected by the GPS receiver 406. The construction machine 4 includes the detection device 420 (420A, 420B) that detects a relative position of the blade edge 440p with respect to the vehicle main body 400. Based on the absolute position of the vehicle main body 400, and a detection result of a detection position 420, an absolute position of the blade edge 440p is obtained. The construction site 3 is constructed by the blade edge 440p, and a current landform is formed. In other words, by identifying the absolute position of the blade edge 440p, an absolute position of a mesh point provided on a surface of the current landform is identified. Thus, the processor 401 can detect a current landform by detecting the absolute position of the blade edge 440p.

The processor 401 of the construction machine 4 wirelessly transmits current landform data to the computer system 2. The current landform data acquisition unit 22 of the computer system 2 wirelessly acquires the current landform data from the construction machine 4.

In this manner, the acquisition of current landform data is not limited to the acquisition using a flight vehicle such as the drone 10, and current landform data may be acquired using the construction machine 4. For example, if an obstacle such as a tree exists in the construction site 3 and it is difficult to cause the drone 10 to fly, current landform data can be smoothly acquired by using the construction machine 4.

In addition, also in the case of executing a dredge work of excavating sediment on a sea bed, a river bed, or the like, a current landform of the sea bed or the river bed can be detected by acquiring trajectory data of the blade edge 440p of the construction machine 4. By the current landform data of the sea bed or the river bed that has been detected using the blade edge 440p, being transmitted to the computer system 2, the current landform data acquisition unit 22 can acquire the current landform data of the sea bed or the river bed. The computer system 2 can cause the mobile terminal 7, the information terminal 8, or the like to display the current landform data of the sea bed or the river bed. In addition, the computer system 2 can cause the mobile terminal 7, the information terminal 8, or the like to display the current landform data of the sea bed or the river bed, and design landform data of the sea bed or the river bed. With this configuration, even in a construction site in which a flight vehicle such as the drone 10 cannot be used, a worker or a manager can check current landform data and design landform data.

In addition, three-dimensional current landform data may be detected by a stereo camera mounted on the construction machine 4. With the stereo camera mounted on the construction machine 4, current landform data being a result constructed by the construction machine 4 itself can be surely acquired. In addition, current landform data can be surely acquired even in a situation in which it is difficult to cause the drone 10 to fly as mentioned above, and even in a region in which current landform data has failed to be acquired by the drone 10. In this manner, the acquisition of current landform data may be performed using both the drone 10 and the stereo camera. In addition, the stereo camera may be the one that is installed in a construction site, and can move.

Alternatively, a three-dimensional laser scanner device that optically acquires current landform data by emitting laser light being detection light, onto a surface of a current landform may be used for acquisition of three-dimensional current landform data. In addition, a triangulation device may be used for acquisition of three-dimensional current landform data.

In addition, in the aforementioned embodiment, the description has been mainly given of an example in which the output device (output device 704, etc.) is a display device. The output device may be a printing device. Output performed by the output device includes printing (print out) performed by the printing device. In other words, each display data (image data and character data) displayed on the display device 704 that has been described in the aforementioned embodiment may be output as a printed matter.

In addition, in the aforementioned embodiment, the description has been given of an example in which the construction machine 4 is an ICT construction machine. If current landform data is acquired in each time using a first detection device such as a drone, a stereo camera, and a three-dimensional laser scanner device, a construction plan (construction plan data) can be presented to a manager or a worker by a construction management system that uses, instead of an ICT construction machine, a normal construction machine not equipped with a device that enables informatization construction.

In addition, in the aforementioned embodiment, design landform data is generated by the information terminal 13 of the construction company 12 or the information terminal 15 of the support center 14, and the design landform data acquisition unit 23 of the computer system 2 acquires the design landform data from the construction company 12 or the support center 14. The design landform data may be generated by the computer system 2 of the construction management system 1. In this case, in place of the design landform data acquisition unit 23 of the computer system 2, or together with the design landform data acquisition unit 23, the computer system 2 may include a design landform data generation unit that generates design landform data.

In addition, in the aforementioned embodiment, design landform data created in the construction company 12 or the support center 14 is acquired by the computer system 2. Design landform data created in the construction company 12 or the support center 14 may be directly transmitted to the construction machine 4 not via the computer system 2 but via the input-output interface circuit 405 of the construction machine 4. In addition, design landform data may be created in the processor 401 of the construction machine 4 instead of being created in the construction company 12 or the support center 14.

[Second Embodiment of Construction Management System]

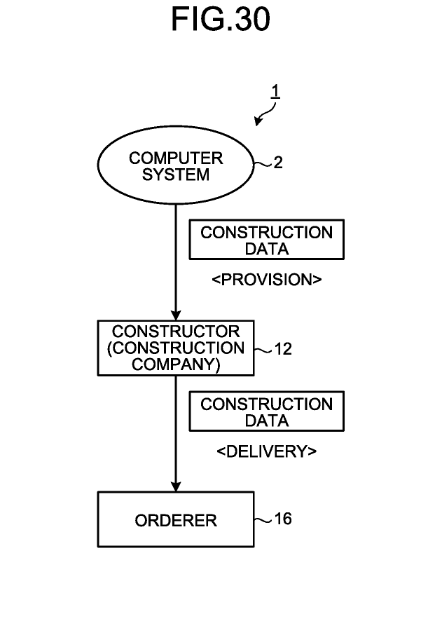

The second embodiment of the construction management system 1 will be described. FIG. 30 is a schematic diagram illustrating an example of the construction management system 1 according to the present embodiment. A constructor (construction company) 12 receives a request from an orderer 16, and executes construction of the construction site 3. After the construction of the construction site 3 is completed, construction data of the construction site 3 is delivered from the constructor 12 to the orderer 16. As construction data delivered from the constructor 12 to the orderer 16, for example, there is current landform data indicating a current landform of the construction site 3 that is obtained after the completion of construction. In addition, as construction data delivered from the constructor 12 to the orderer 16, there is map data indicating a difference between the current landform data obtained after the completion of construction, and design landform data indicating a target design landform to be obtained after the completion of construction.

In the present embodiment, the computer system 2 provides the constructor 12 with construction data including the current landform data of the construction site 3 that is obtained after the completion of construction. The current landform data obtained after the completion of construction is acquired using the drone 10 after the completion of construction, for example. The computer system 2 provides the constructor 12 with construction data including current landform data acquired by the current landform data acquisition unit 22.

If construction data is electronically delivered from the constructor 12 to the orderer 16, the constructor 12 delivers electronic data of construction data provided from the computer system 2, to the orderer 16. Based on the delivered construction data, the orderer 16 can check whether the construction of the construction site 3 has been appropriately executed.

Nevertheless, the construction data provided from the computer system 2 to the constructor 12 may be altered by the constructor 12, and the altered construction data may be delivered to the orderer 16. If the constructor 12 compares current landform data acquired after the completion of construction, and design landform data, and the both landform data do not match, the constructor 12 may alter the current landform data acquired after the completion of construction, so as to match the design landform data, for avoiding the trouble of performing construction again.

In the present embodiment, using an authentication technique, the computer system 2 checks whether construction data delivered from the constructor 12 to the orderer 16 is altered construction data.

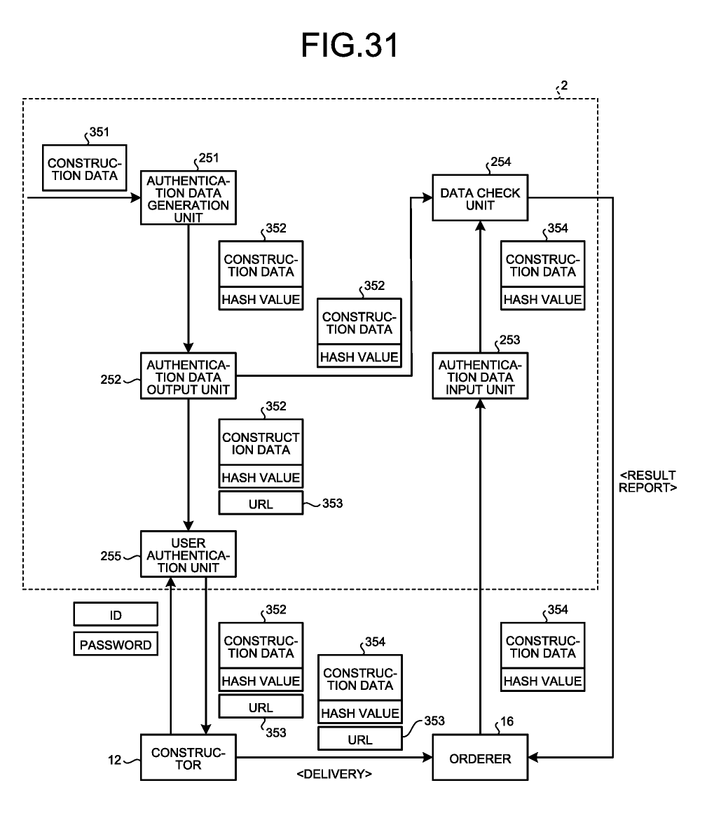

FIG. 31 is a functional block diagram illustrating an example of the construction management system 1 according to the present embodiment. As illustrated in FIG. 31, the computer system 2 includes an authentication data generation unit 251 that generates code-added construction data 352 by adding an authentication code to construction data 351 of the construction site 3, an authentication data output unit 252 that outputs the code-added construction data 352 generated by the authentication data generation unit 251, an authentication data input unit 253 to which code-added construction data 354 is input from an external device, and a data authentication unit 254 that compares the authentication code of the code-added construction data 352 output from the authentication data output unit 252, and an authentication code of the code-added construction data 354 input to the authentication data input unit 253, and determines whether the both authentication codes match.

In addition, the computer system 2 includes a user authentication unit 255 that executes approval or disapproval of access to the authentication data output unit 252.

The authentication data generation unit 251 acquires, as the construction data 351, current landform data obtained after the completion of construction, from the current landform data acquisition unit 22, for example. The authentication data generation unit 251 adds an authentication code to the construction data 351 to generate the code-added construction data 352. In the present embodiment, the authentication code includes a hash value generated from the construction data 351 using a hash function. The authentication data generation unit 251 adds a hash value to the construction data 351 to generate the code-added construction data 352.

The authentication data output unit 252 outputs the code-added construction data 352 generated by the authentication data generation unit 251, to the constructor 12. The authentication data output unit 252 transmits, via the internet, the code-added construction data 352 to the information terminal 13 of the constructor 12.

In the present embodiment, the constructor 12 that can acquire the code-added construction data 352 from the authentication data output unit 252 is limited. Only the constructor 12 being under contract with the computer system 2 (construction management system 1) can access the authentication data output unit 252, and acquire the code-added construction data 352 from the authentication data output unit 252. In the present embodiment, the user authentication unit 255 executes approval or disapproval of access of the constructor 12 to the authentication data output unit 252. In the present embodiment, the user authentication unit 255 authenticates the constructor 12 through password authentication. The constructor 12 inputs an identification (ID) and a password from the information terminal 13. Based on the input ID and password, the user authentication unit 255 determines whether the accessing constructor 12 is a constructor 12 being under contract with the computer system 2. If it is determined in the user authentication unit 255 that the accessing constructor 12 is a constructor 12 being under contract, access of the constructor 12 to the authentication data output unit 252 is approved.

In the present embodiment, the authentication data output unit 252 outputs detection data for accessing the authentication data input unit 253, together with the code-added construction data 352. In the present embodiment, the detection data includes a uniform resource locator (URL) 353. The authentication data output unit 252 outputs the URL 353 for accessing a specific work area of the authentication data input unit 253, together with the code-added construction data 352.

The constructor 12 provided with the code-added construction data 352 from the authentication data output unit 252 delivers the code-added construction data 352 to the orderer 16. In the following description, code-added construction data delivered from the constructor 12 to the orderer 16 will be referred to as the code-added construction data 354.

For checking whether the code-added construction data 352 provided from the authentication data output unit 252 to the constructor 12, and the code-added construction data 354 delivered from the constructor 12 to the orderer 16 match, using an information terminal owned by the orderer 16, for example, the orderer 16 accesses the authentication data input unit 253 using the URL 353 delivered together with the code-added construction data 354. The orderer 16 uploads (inputs) the code-added construction data 354 into the specific work area of the authentication data input unit 253 that is designated by the URL 353. At this time, the orderer 16 can access the authentication data input unit 253 without inputting an ID and a password. Nevertheless, the computer system 2 may request an input of an ID and a password when the orderer 16 accesses the authentication data input unit 253.

The code-added construction data 354 uploaded into the authentication data input unit 253 is supplied to the data authentication unit 254. In addition, the code-added construction data 352 is supplied from the authentication data output unit 252 to the data authentication unit 254.

The data authentication unit 254 compares a hash value of the code-added construction data 352 output from the authentication data output unit 252, and a hash value of the code-added construction data 354 uploaded into the authentication data input unit 253. By comparing the hash values of the both data, the data authentication unit 254 determines whether current landform data of the code-added construction data 352 output from the authentication data output unit 252, and current landform data of the code-added construction data 354 uploaded into the authentication data input unit 253 match.

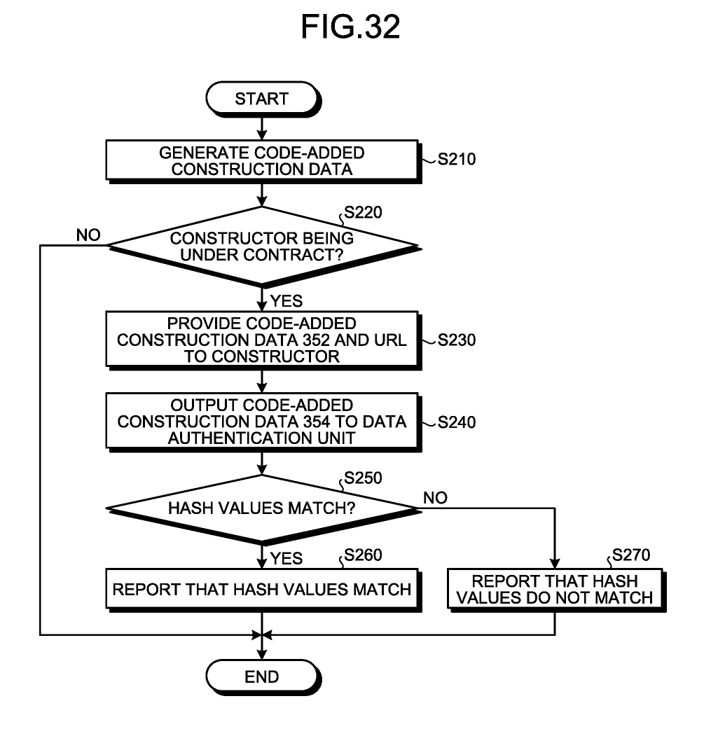

Next, an example of a construction management method according to the present embodiment will be described with reference to a flowchart in FIG. 32. The authentication data generation unit 251 acquires the construction data 351, and generates a hash value from the construction data 351 using the hash function. Authentication data 251 adds the hash value to the construction data 351 to generate the code-added construction data 352 (Step S210).

For acquiring the code-added construction data 352, the constructor 12 inputs an ID and a password using the information terminal 13, for example. Based on the ID and the password, a user recognition unit 255 executes approval or disapproval of access of the constructor 12 to the authentication data output unit 252. Based on the ID and the password, the user recognition unit 255 determines whether the accessing constructor 12 is a constructor 12 being under contract with the management system 1 (Step S220).

If it is determined in Step S220 that the accessing constructor 12 is not a constructor 12 being under contract with the management system 1 (Step S220: No), the code-added construction data 352 is not provided to the constructor 12, and the processing ends.

If it is determined in Step S220 that the accessing constructor 12 is a constructor 12 being under contract with the management system 1 (Step S220: Yes), the code-added construction data 352 and the URL 353 are provided from the authentication data output unit 252 to the constructor 12 via the internet (Step S230).

The code-added construction data 354 is delivered from the constructor 12 to the orderer 16. The orderer 16 accesses the URL 353 provided from the authentication data output unit 252, and uploads (inputs) the code-added construction data 354 delivered from the constructor 12, into the specific work area of the authentication data input unit 253 that is designated by the URL 353.

The code-added construction data 354 uploaded into the authentication data input unit 253 is supplied to the data authentication unit 254. In addition, the code-added construction data 352 is supplied from the authentication data output unit 252 to the data authentication unit 254 (Step S240).

The data authentication unit 254 compares a hash value of the code-added construction data 352 output from the authentication data output unit 252, and a hash value of the code-added construction data 354 input to the authentication data input unit 253. Based on the two hash values, a data recognition unit 254 determines whether construction data (current landform data) of the code-added construction data 352 output from the authentication data output unit 252, and construction data (current landform data) of the code-added construction data 354 input to the authentication data input unit 253 match (Step S250).

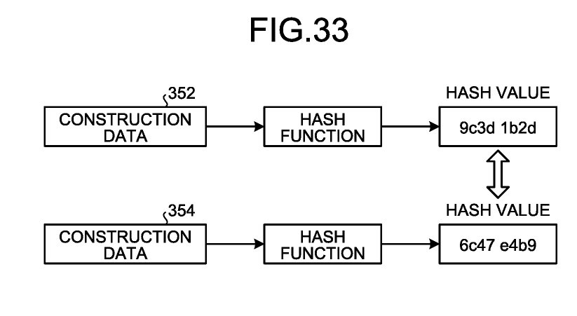

FIG. 33 is a schematic diagram illustrating an example of the construction management method according to the present embodiment. Using the hash function, a hash value is generated from construction data of the code-added construction data 352. In addition, using the hash function, a hash value is generated from construction data of the code-added construction data 354. If construction data is not altered in the constructor 12, the hash value generated from the construction data of the code-added construction data 352 and the hash value generated from the construction data of the code-added construction data 354 match. On the other hand, if construction data is altered in the constructor 12, and the construction data of the code-added construction data 352 and the construction data of the code-added construction data 354 are not identical, as illustrated in FIG. 33, the hash value generated from the construction data of the code-added construction data 352 and the hash value generated from the construction data of the code-added construction data 354 do not match

If it is determined in Step S250 that the construction data of the code-added construction data 352 and the construction data of the code-added construction data 354 match (Step S250: Yes), it is reported to the orderer 16 that the construction data generated in the computer system 2, and the construction data delivered to the orderer 16 match, and construction data is not altered (Step S260).

If it is determined in Step S250 that the construction data of the code-added construction data 352 and the construction data of the code-added construction data 354 do not match (Step S250: No), it is reported to the orderer 16 that the construction data generated in the computer system 2, and the construction data delivered to the orderer 16 do not match, and construction data may be not altered (Step S270).

As described above, according to the present embodiment, whether the construction data of the code-added construction data 352 and the construction data of the code-added construction data 354 match is determined by the orderer 16 comparing the hash value of the code-added construction data 352 including the construction data 351 of the construction site 3 that has been generated by the computer system 2, and the hash value of the code-added construction data 354 delivered from the constructor 12. Thus, whether data has been altered in the constructor 12 can be determined.

In addition, in the present embodiment, the authentication data output unit 252 outputs the URL 353 for the orderer 16 accessing the authentication data input unit 253, together with the code-added construction data 352. The orderer 16 can thereby upload the code-added construction data 354 into the authentication data input unit 253 designated by the URL 353. Thus, the data authentication unit 254 can compare the hash value of the code-added construction data 352, and the hash value of the code-added construction data 354.

In addition, in the present embodiment, the user authentication unit 255 that executes approval or disapproval of access to the authentication data output unit 252 is provided. With this configuration, only a user (constructor 12) being under contract with the construction management system 1 can be approved to directly access the construction data 351 and the code-added construction data 352, and a user (orderer 16 or the like) not being under contract with the construction management system 1 can be prohibited from directly accessing the construction data 351 and the code-added construction data 352.

In addition, in the present embodiment, an authentication code loaded on the construction data 351 is assumed to be a hash value. The authentication code is only required to be a message authentication code (MAC) used in a message authentication technique, and, for example, a symmetric-key cryptography may be used.

### REFERENCE SIGNS LIST

1 CONSTRUCTION MANAGEMENT SYSTEM
2 COMPUTER SYSTEM
3 CONSTRUCTION SITE
4 CONSTRUCTION MACHINE
4A EXCAVATOR
4B BULLDOZER
5 TRANSPORTER VEHICLE
6 GPS SATELLITE
7 MOBILE TERMINAL
8 INFORMATION TERMINAL
9 SITE OFFICE
10 DRONE
11 CAMERA
12 CONSTRUCTION COMPANY
13 INFORMATION TERMINAL
14 SUPPORT CENTER
15 INFORMATION TERMINAL
20 CONSTRUCTION PLAN DATA CALCULATION UNIT
21 CONSTRUCTION RESULT DATA ACQUISITION UNIT
22 CURRENT LANDFORM DATA ACQUISITION UNIT
23 DESIGN LANDFORM DATA ACQUISITION UNIT
24 CONSTRUCTION AMOUNT DATA CALCULATION UNIT
25 MODE DATA ACQUISITION UNIT
26 ORIGINAL UNIT DATA ACQUISITION UNIT
27 CONSTRUCTION CONDITION DATA ACQUISITION UNIT
28 CONSTRUCTION PATTERN ACQUISITION UNIT
29 VARIATION FACTOR DATA ACQUISITION UNIT
30 TRANSPORT CONDITION DATA ACQUISITION UNIT
31 CLIENT DATA ACQUISITION UNIT
32 CONSTRUCTION PLAN DATA OUTPUT UNIT
33 REMOTE CONTROL UNIT
41 ORIGINAL UNIT DATA STORAGE UNIT
42 CONSTRUCTION CONDITION DATA STORAGE UNIT
43 CONSTRUCTION PATTERN STORAGE UNIT
44 VARIATION FACTOR DATA STORAGE UNIT
45 CLIENT DATA STORAGE UNIT
46 RESULT STORAGE UNIT
50 INPUT UNIT
251 AUTHENTICATION DATA GENERATION UNIT
252 AUTHENTICATION DATA OUTPUT UNIT
253 AUTHENTICATION DATA INPUT UNIT
254 DATA AUTHENTICATION UNIT
255 USER AUTHENTICATION UNIT
351 CONSTRUCTION DATA
352 CODE-ADDED CONSTRUCTION DATA
353 URL
354 CODE-ADDED CONSTRUCTION DATA
Ma WORKER
Mb WORKER
Mc WORKER

1. A construction management system comprising:
a construction plan data calculation unit configured to calculate, based on construction plan data indicating a construction plan of a construction site, the construction plan data having been calculated based on a current landform and a design landform of the construction site and original unit data indicating a specific condition of a work device, necessary work device data indicating a work device necessary for executing construction of the construction site using the construction plan; and
a construction plan data output unit configured to cause an output device to output the necessary work device data.

2. The construction management system according to claim 1,
wherein the construction plan data calculation unit is configured to calculate the necessary work device data based on the construction plan data and client data indicating a work device owned by a client.

3. The construction management system according to claim 2,
wherein the necessary work device data includes data indicating a work device determined to be deficient in execution of the construction.

4. The construction management system according to claim 1,
wherein, based on the necessary work device data, provision data indicating procurement information related to a work device providable for compensating for the deficiency is output to the output device.

5. The construction management system according to claim 4,
wherein the provision data includes rental data indicating a rentable work device.

6. The construction management system according to claim 4,
wherein the construction plan data output unit is configured to cause the output device to output the provision data after causing the output device to output the construction plan data.

7. The construction management system according to claim 6,
wherein the output device includes a display device, and
wherein when it is determined that the client does not own a work device indicated by the construction plan data or owns only a part of work devices indicated by the construction plan data, the construction plan data output unit causes a display screen of the display device to automatically transition from a display screen including the construction plan data, to a display screen including the provision data.

8. The construction management system according to claim 1,
wherein the construction plan data output unit is configured to designate a specific storage facility from among a plurality of storage facilities in which work devices are stored, based on a position of the construction site.

9. The construction management system according to claim 1,
wherein the construction plan data calculation unit is configured to calculate, for each of a plurality of target construction periods, the construction plan data including the construction plan and a construction cost required when construction is executed using the construction plan, and calculate the necessary work device data for each of the plurality of target construction periods based on a plurality of the calculated construction plan data and the client data.

10. The construction management system according to claim 1,
wherein the construction plan data calculation unit is configured to calculate the construction plan data based on a construction pattern selected according to an input signal of an input unit from among a plurality of construction patterns of the work device that is stored in a construction pattern storage unit, and calculate the necessary work device data based on the calculated construction plan data and the client data.

11. A construction management system comprising:
a construction plan data calculation unit configured to calculate, based on construction plan data indicating a construction plan of a construction site, the construction plan data having been calculated based on a current landform and a design landform of the construction site and original unit data indicating a specific condition of a work device, and client data indicating a work device owned by a client, necessary work device data indicating a work device necessary for executing construction of the construction site using the construction plan; and
a construction plan data output unit configured to cause, based on the necessary work device data, a display device to display a rental service screen of a work device so as to compensate for a work device determined to be deficient in executing construction based on the construction plan.

12. A construction management system comprising:
an authentication data output unit configured to output code-added construction data obtained by adding an authentication code to construction data of a construction site;
an authentication data input unit to which code-added construction data is input from an external device; and
a data authentication unit configured to compare an authentication code of code-added construction data output from the authentication data output unit, and an authentication code of code-added construction data input to the authentication data input unit, to determine whether construction data of the code-added construction data output from the authentication data output unit matches construction data of the code-added construction data input to the authentication data input unit.

13. The construction management system according to claim 11,
wherein the data authentication unit is configured to compare an authentication code output from the authentication data output unit and an authentication code input to the authentication data input unit.

14. The construction management system according to claim 12,
wherein the authentication data output unit is configured to output detection data for accessing the authentication data input unit, together with the code-added construction data, and
wherein the code-added construction data is input from the external device to the authentication data input unit designated by the detection data.

15. The construction management system according to claim 12, comprising
a user authentication unit configured to execute approval or disapproval of access to the authentication data output unit.

16. A construction management method comprising:
calculating, based on a current landform and a design landform of a construction site and original unit data indicating a specific condition of a work device, construction plan data indicating a construction plan of the construction site;
calculating, based on the construction plan data, necessary work device data indicating a work device necessary for executing construction of the construction site using the construction plan; and
causing an output device to output the necessary work device data.

17. The construction management method according to claim 16, comprising
acquiring client data indicating a work device owned by a client,
wherein the necessary work device data is calculated based on the construction plan data and the client data.

18. A construction management method comprising:
calculating, based on a current landform and a design landform of a construction site and original unit data indicating a specific condition of a work device, construction plan data indicating a construction plan of the construction site;
acquiring client data indicating a work device owned by a client;
calculating, based on the construction plan data and the client data, necessary work device data indicating a work device necessary for executing construction of the construction site using the construction plan; and
causing, based on the necessary work device data, a display device to display a rental service screen of a work device so as to compensate for a work device determined to be deficient in executing construction based on the construction plan.
